(19) United States
(12) Patent Application Publication
(10) Pub. No.: US 2026/0104531 A1
(43) Pub. Date: Apr. 16, 2026

(54) AUTOMATIC METHOD FOR FORECASTING STRONG COLD WAVES FROM HORIZONTAL-TO-VERTICAL TROUGH TRANSITION USING WAVE TRUNCATION

(71) Applicant: Chengdu University of Information Technology, Chengdu (CN)

(72) Inventors: Wendong Hu, Chengdu (CN); Fei Luo, Chengdu (CN); Yukun Yang, Chengdu (CN); Zhiliang Shu, Chengdu (CN); Jianhong Gan, Chengdu (CN); Yang Cui, Chengdu (CN); Tiangui Xiao, Chengdu (CN); Ying Zhang, Chengdu (CN); Minhong Song, Chengdu (CN); Wenjie Zhou, Chengdu (CN); Yu Peng, Chengdu (CN); Yanqiong Hao, Chengdu (CN); Jingyi Tao, Chengdu (CN)

(21) Appl. No.: 19/356,088

(22) Filed: Oct. 11, 2025

(30) Foreign Application Priority Data
Oct. 11, 2024 (CN) 202411418399.5

(51) Int. Cl. G01W 1/10

(52) U.S. Cl. CPC G01W 1/10

(57) ABSTRACT

The present application provides an automatic method for forecasting strong cold waves from horizontal-to-vertical trough transition using wave truncation, which includes: reading geopotential height data within a 500 hPa forecast key region in forecasting operations, and converting a screen coordinate system into a Cartesian coordinate system; analyzing contour lines of the geopotential height field; repeatedly truncating and splitting waves to extract truncation points; selecting trough candidate nodes from a set of truncation points; screening trough candidate nodes and organizing and constructing a trough line; detecting a slope of the trough fitting line to find a horizontal trough; calculating a north-south extension distance of the found horizontal trough; comparing this north-south extension distance with a north-south extension distance at a next time; and in a case where an increase amount exceeds a preset threshold, determining the start of a horizontal-to-vertical trough transition, thereby forecasting an intense cold wave.

### CROSS-REFERENCE TO RELATED APPLICATIONS

This application claims priority to Chinese Patent Application No. 202411418399.5, filed on Oct. 11, 2024, which is hereby incorporated by reference in its entirety.

### TECHNICAL FIELD

The present application belongs to the field of information management for forecasting, prediction and decision-making of large-scale severe meteorological disasters, and particularly relates to an automatic method for forecasting strong cold waves from horizontal-to-vertical trough transition using wave truncation.

### BACKGROUND

A cold wave is an intense cold air activity originating from the polar or frigid zone and invading lower-latitude regions, and is defined in meteorology as a large-scale violent outbreak of strong cold air. Not all cold air invasion processes are referred to as cold waves, but when the minimum temperature is below 4° C. and the air temperature decreases by more than 8° C. within 24 hours, or decreases by more than 10° C. within 48 hours, or decreases by more than 12° C. within 72 hours, such an intense activity of strong cold air is defined as a cold wave.

On an upper-air weather chart, waves caused by cold and warm air masses always appear in the westerly belt. A leading edge of cold air moving southward and eastward from the north appears as a trough, also referred to as a cold trough or low trough, which is a valley region of the wave. A leading edge of warm air moving northward and eastward from the south appears as a ridge, also referred to as a warm ridge or high ridge, which is a peak region of the wave. Most of the upper air over the majority of regions in China is located within the westerly belt. The most common troughs and ridges are shown in FIG. 1, representing the cold and warm air masses moving from west to east. Such troughs extending from north to south are also referred to as vertical troughs. In this figure, the bold arrow indicates the movement direction of the trough.

In winter, extremely strong cold air accumulates in the frigid zone and moves from north to south, appearing as a horizontal trough on an upper-air chart, as shown by A in FIG. 2. When extremely northern and highly intense cold air, namely the horizontal trough A, moves southward, the cold air enters the westerly belt, and the movement direction changes to west-to-east movement, forming a vertical trough B. This process is referred to as the transition from a horizontal trough to a vertical trough. A represents the horizontal trough with southward-moving cold air, and B represents the vertical trough with eastward-moving cold air. The process from A to B is the transition from a horizontal trough to a vertical trough, which causes a strong cold wave.

In forecasting operations, cold wave processes on the 500 hPa geopotential height field are divided into three major types: 1) small trough development; 2) eastward-moving low trough; and 3) horizontal-to-vertical trough transition.

Among the three major types of cold waves, the horizontal-to-vertical trough transition is extremely intense. Therefore, a strong cold wave process, causing a nationwide extensive cold temperature drop, frost, heavy snow, rain-snow mix and freezing in southern regions, strong wind, and dust storms in northern and central regions, is mostly caused by the horizontal-to-vertical trough transition.

The cold wave is a weather process with the largest affected area, affecting a region far exceeding that of heavy rain, typhoon, and other weather phenomena, and a variety of high-intensity disasters accompany the cold wave process, attracting widespread attention and having considerable forecasting difficulty.

In current conventional cold wave forecasting operations, a large amount of manual subjective judgment and experience support is required in specific procedures, feature recognition is difficult, automation and intelligence have not been achieved, and the process is time-consuming, labor-intensive, and inefficient. This not only increases the workload of forecasting personnel, but also affects the objectivity and consistency of forecasting results. Manual identification of a cold wave requires forecasting personnel to have rich experience and professional knowledge, as well as an in-depth understanding of meteorological principles, otherwise misjudgment or omission may easily occur. Manual identification of a cold wave is affected by human factors, such as subjective judgment, fatigue level, and attention of forecasting personnel, which may result in unstable and inconsistent identification. Manual identification of a cold wave has low efficiency, and timely and continuous monitoring and warning require high labor intensity. Therefore, how to automatically extract key variables in a complex weather system and perform accurate forecasting and prediction is a significant challenge currently faced by cold wave forecasting technology at the operational level.

### SUMMARY

Aiming at the defects in the prior art, the present application provides an automatic method for forecasting strong cold waves from horizontal-to-vertical trough transition using wave truncation, which improves the accuracy and timeliness of cold wave forecasting, reduces manual labor, decreases the impact of cold wave disasters on society, and enhances the level of automation. The present application targets cold waves from horizontal-to-vertical trough transition, which have the widest impact and cause the most severe disasters, and achieves automated forecasting through technological innovation.

To achieve the above objective, the present application uses the following technical solutions. An automatic method for forecasting strong cold waves from horizontal-to-vertical trough transition using wave truncation includes the following steps:
S1. reading geopotential height data within a 500 hPa forecast key region in forecasting operations, and converting a screen coordinate system into a Cartesian coordinate system;
S2. performing contour analysis on the geopotential height data, extracting trough candidate nodes by a wave truncation method according to the analysis result, and constructing a trough line organization to identify the trough line;
S3. calculating a slope of each segmented trough fitting line;
S4. judging whether the slope is less than 1; if so, generating a horizontal trough and proceeding to S5; otherwise, generating a vertical trough, and calculating data at a next time to search for a horizontal trough; if no horizontal trough appears in all times, outputting no horizontal trough and ending the process;
S5. marking and numbering the trough candidate nodes, and calculating a north-south vertical length of the horizontal trough from coordinates of start and end points; and
S6. judging whether horizontal-to-vertical trough transition occurs based on changes in the north-south vertical length of the horizontal trough, thereby completing forecasting of the strong cold waves from horizontal-to-vertical trough transition.

Further, the S1 includes the following steps:
S101. reading the geopotential height data within the 500 hPa forecast key region in forecasting operations, where the geopotential height data is three-dimensional data, including grid spacing of time interval, latitude, and longitude;
S102. performing geographic region selection on the read geopotential height data, calculating required latitude and longitude ranges, and extracting data within a corresponding region; and
S103. based on the extracted data within the corresponding region, converting the screen coordinate system into the Cartesian coordinate system by the following formula:

$$y = height - {y}^{*}$$

where y represents vertical coordinate in the Cartesian coordinate system, height represents a vertical height of the screen, and y* represents a vertical coordinate in the screen coordinate system.

Further, the S2 includes the following steps:
S201. creating a two-dimensional array data_t and performing contour analysis on the geopotential height data, and distributing the contour line nodes into a list contours according to elevation levels, where contours represents a list containing all sets of contour line nodes, and the two-dimensional array data_t is configured to store geopotential height data within a range of 90° N-40° N and 70° E-140° E at a time t;
S202. traversing each contour line in the list contours, and storing the contour line nodes sequentially as triplets into a list all_points, where each contour line includes waves of a plurality of points;
S203. extracting truncation points using a wave truncation method, and determining the trough candidate nodes by a positive value of vector cross product;
S204. searching for a minimum value point in the two-dimensional array data_t and inserting the point into a trough candidate node list trough_list;
S205. based on the trough candidate node list trough_list, screening the candidate nodes according to an overall principle of the trough line tending westward, southward, and linear, forming the trough node organization, and constructing the trough node organization into a fitting trough line list fitting_line; and
S206. judging whether a closed contour exists using a convex hull algorithm, if so, searching for a minimum position of a region of the closed contour, reorganizing a trough line node list, and completing the identification of the trough line.

Further, the S201 includes the following steps:
S2011. selecting a maximum geopotential height Hmax0 and a minimum geopotential height Hmin0 within the selected geographic region, where contour analysis is performed on a 500 hPa geopotential height field with 5000 gpm as a reference at intervals of 40 gpm;
S2012. creating the two-dimensional array data_t configured to store geopotential height data within the range of 90° N-40° N and 70° E-140° E at the time t; and
S2013. performing contour analysis on the two-dimensional array data_t, and distributing the contour line nodes into the list contours according to elevation levels.

Further, the S203 includes the following steps:
S2031. constructing a straight line using start and end points of an original multi-wave curve, calculating a distance from each point on the original multi-wave curve to the straight line, and taking a point with a maximum distance as a first-level truncation point; S2032. based on the first-level truncation point, dividing an original large multi-wave curve into two shortest sub-curves, connecting start and end points of the two sub-curves to form two new straight lines, calculating a distance from each point of the two sub-curves to a corresponding new straight line, and calculating and searching for a point with a maximum distance as a second-level truncation point;
S2033. repeating steps S2031 and S2032 until a maximum distance from points on the sub-curve to the corresponding straight line is less than a preset first distance threshold, thereby completing extraction of truncation points;
S2034. defining an order of previous and next points in a truncation point set: taking a current point as P, a previous point as Pₚᵣₑᵥ, and a next point as Pₙₑₓₜ;
S2035. calculating vectors V₁ and V₂ for the previous and next points according to and the defined points;

$${V}_{1} = P - {P}_{prev}$$

$${V}_{2} = {P}_{next} - P$$

S2036. performing a cross product calculation on the two vectors V₁ and V₂;

$${V}_{1} = ( {v}_{1 x} , {v}_{1 y} )$$

$${V}_{2} = ( {v}_{2 x} , {v}_{2 y} )$$

$${V}_{1} \times {V}_{2} = {v}_{1 x} {v}_{2 y} - {v}_{1 y} {v}_{2 x}$$

where v₁ₓ, v_{1y} represents components of the vector V₁ in x and y directions, respectively; and v₂ₓ, v_{2y} represents components of the vector V₂ in x and y directions, respectively; and
S2037. in a case where the cross product result is positive, defining the current point as a trough candidate node, thereby judging and identifying the trough candidate node from the truncation point set.

Further, the S205 includes the following steps:
S2051. sorting the trough candidate node list trough_list according to geopotential height;
S2052. grouping trough candidate nodes in the sorted trough candidate node list trough_list according to contour lines on which the nodes are located, and storing a grouping result into a list collected_list;
S2053. constructing a list now_isotherm_point_index_list configured to store indexes of nodes currently selected to form the trough fitting line, where an initial value is an index 0 of a first point, that is, a minimum value point in the two-dimensional array data_t;
S2054. constructing a list fitting_line configured to store the selected trough line nodes in the form of a dictionary;
S2055. sequentially traversing each contour line in the list collected_list, creating empty lists each_contour_distance_list and angle_list for each contour line in collected_list starting from index 1, taking a last node in the current trough fitting line as start_point, traversing trough candidate nodes in each contour line, and calculating a Euclidean distance distance between each trough candidate node in a current contour and the last node start_point in the current trough fitting line:

$$distance = \sqrt{{( x - {x}_{0} )}^{2} + {( y - {y}_{0} )}^{2}}$$

where x₀ represents x-coordinate of a node each_point in the current contour, y₀ represents y-coordinate of the node each_point in the current contour, x represents x-coordinate of a node start_point in the current trough fitting line, y represents y-coordinate of the node start_point in the current trough fitting line, and both the node each_point and the node start_point are trough candidate nodes;
S2056. determining a position of the node each_point relative to the node start_point by the following formula:

$$dx = each\_point \_x - start\_point \_x$$

$$dy = each\_point \_y - start\_point \_y$$

where dx and dy represent positions of the node each_point relative to the node start_point, each_point_x and each_point_y represent an x-coordinate and a y-coordinate of the node each_point, respectively, and start_point_x and start_point_y represent an x-coordinate and a y-coordinate of the node start_point, respectively;
S2057. in a case where dx<0, that is, the node each_point is on the left side of the node start_point, and a number of points currently selected to form the trough fitting line stored in the list now_isotherm_point_index_list is greater than or equal to 2, calculating angles among the current node each_point and last two nodes in the list now_isotherm_point_index_list, where the last two nodes for calculation are the most recently selected nodes stored in the list now_isotherm_point_index_list forming the trough fitting line, and storing the angles among the three nodes into the list angle_list, where the three nodes includes the current node and the last two nodes, and the angles are formed by the current node each_point and the last two nodes in the list now_isotherm_point_index_list, with the last node in the list now_isotherm_point_index_list located at the center;
in a case where dx<0, that is, the node each_point is on the left side of the node start_point, and dy>0, that is, the node each_point is above the node start_point, calculating a distance between the node each_point and the node start_point, and adding the distance between the node each_point and the node start_point to the list each_contour_distance_list; otherwise, multiplying the distance between the node each_point and the node start_point by a second distance threshold, and adding a result of multiplication to the list each_contour_distance_list;
in a case where dx>0, that is, the node each_point is on the right side of the node start_point, setting a distance to 99999 according to meteorological business specifications, and adding the distance to the list each_contour_distance_list; and setting an angle to 90°, and adding the angle to the list angle_list; and
S2058. screening the three cases of S2057 to obtain the fitting trough line list fitting_line.

Further, the S2058 includes the following steps:
S20581. searching for a trough candidate node in the current contour that is closest to the node start_point, and recording an index of a minimum distance as minize_index:

$$minize\_index = {\underbrace{arg min}}_{{i}^{′}} \{ distance ( {point}_{i} , start\_point ) \}$$

where minize_index represents the index of the minimum distance, argmin represents an index that minimizes an objective function distance (pointᵢ, start_point), pointᵢ represents a trough candidate node in the current contour currently being used to calculate the distance to the node start_point, and i′ represents an index of the trough candidate node in the current contour that is closest to the node start_point;
S20582. calculating a difference angle_diff_{[j]} between each angle in the list angle_list and 180°:

$${angle\_diff}_{[ j ]} = \vert {angle\_list}_{[ j ]} - 180 ° \vert$$

where angle_list_{[j]} represents a list used for recording and storing angles angle among three nodes, including a current trough candidate node j and the last two nodes in the list of the most recently selected nodes forming the trough fitting line;
S20583. in a case where |angle_list|≥2 and |now_isotherm_point_index_list|≥3, then

$$nearest\_flatten \_angle \_index = {\underbrace{arg min}}_{{i}^{′}} \{ {angle\_diff}_{[ j ]} \} ;$$

where angle_list≥2 represents that the number of angles existing in the list angle_list is greater than 2, |now_isotherm_point_index_list|≥3 represents that the number of points existing in the list now_isotherm_point_index_list is greater than 3, and

$$nearest\_flatten \_angle \_index = {\underbrace{arg min}}_{{i}^{′}} \{ {angle\_diff}_{[ j ]} \}$$

represents updating the index nearest_flatten_angle_index to point to a trough candidate node whose an included angle with a previous trough fitting line is closest to 180°;
S20584. comparing whether the index nearest_flatten_angle_index is inconsistent with the index minize_index; in a case where nearest_flatten_angle_index≠minize_index, and each_contour_distance_list[nearest_flatten_angle_index] is less than or equal to a first threshold, updating the index minize_index to the index preset nearest_flatten_angle_index;
S20585. adding coordinates of a node in the current contour line that satisfies a fitting condition of a trough fitting line to the fitting trough line list fitting_line, and adding an index of the node to the list now_isotherm_point_index_list; updating count by increasing the number of the currently selected nodes forming the trough fitting line by one, and performing the next traversal; in a case where a length of the list each_contour_distance_list is 1 and the value exceeds a set second threshold, indicating that only one point exists in the current contour line and the distance is the maximum, ending the loop and stopping the extension of the trough line, where count represents a total number of currently selected nodes forming the trough fitting line, and the node satisfying the fitting condition of the trough fitting line corresponds to the index minize_index; and
S20586. storing information of trough candidate nodes corresponding to all indexes in the list now_isotherm_point_index_list into the list contours_list_with_line, so as to complete the fitting of the trough line.

Further, the S206 specifically is as follows:
calculating a distance between a start point and an end point of each contour line;
in a case where the distance is less than a preset third threshold, judging that a point set array contour_data is approximately closed; or
in a case where the distance is equal to the preset third threshold, judging that the point set array contour_data is approximately closed;
storing minimum positions of regions of all closed contour lines into a list closed_min_list;
truncating a trough fitting line node list contours_list_with_line into a plurality of sublists according to the minimum positions of the closed regions; and
inserting a minimum position of each closed region at the beginning of each sublist, sorting the trough fitting line node list contours_list_with_line according to height values, and updating a fitting trough line list fitting_line.

Further, the S3 includes the following steps:
S301. analyzing a list contours_list_with_line to judge whether the list includes segmented sublists; if so, proceeding to step S303; otherwise, proceeding to step S302;
S302. calculating slopes between trough line nodes, obtaining an average value of the slopes, taking the average value as a slope of a trough fitting line, and storing the slope of the trough fitting line:

$$slope = \frac{1}{{n}^{′}} {\sum }_{{i}^{″} = 0}^{{n}^{′} - 1} slope\_list [ i ]$$

$$slpoe\_list [ i ] = \frac{{y}_{i + 1} - {y}_{i}}{{x}_{i + 1} - {x}_{i}}$$

where slope represents the slope of the trough fitting line, n′ represents the number of data in the list slope_list, i″ represents an index of data in the list slope_list and slpoe_list[i] represents a list of slopes between each trough line node point′ᵢ and a next trough line node point′ᵢ₊₁ thereof; and
S303. sequentially traversing the trough line nodes in each segmented sublist, calculating slopes between the trough line nodes in each segmented sublist, obtaining an average value of the slopes as an average slope of each segmented sublist, performing an averaging process on the average slopes of all the segmented sublists to obtain a slope of a trough fitting line of all the segmented sublists, and storing the slope of the trough fitting line of all the segmented sublists:

$$slope = \frac{1}{m} {\sum }_{{j}^{′} = 0}^{m - 1} me an \_ slope {\_j}^{′} [ j ]$$

$$mean \_ slope {\_ j}^{′} [ j ] = \frac{1}{{n}_{{j}^{′}}} {\sum }_{{i}^{″} = 0}^{{{n}_{j}}^{′} - 1} slope \_ list \_ j [ i ]$$

$$slope \_ list \_ j [ i ] = \frac{{y}_{i + 1} - {y}_{1}}{{x}_{i + 1} - {x}_{i}}$$

where slope represents the slope of the trough fitting line of all the segmented sublists, m represents the number of data in the list mean_slope_j′, j′ represents an index of data in the list mean_slope_j′, mean_slope_j′[j] represents a list of average slopes of the trough fitting lines of each segmented sublist, n_{j′} represents the number of data in the list slope_list_j[i], i″ represents an index of data in the list slope_list_j. slope_list_j[i] represents a list of slopes of straight lines between each trough line node point′ᵢ and a next trough line node point′ᵢ₊₁ in each segmented sublist sublistⱼ, xᵢ and yᵢ represent an x-coordinate and a y-coordinate of the trough line node point′ᵢ, respectively, and xᵢ₊₁ and yᵢ₊₁ represent an x-coordinate and a y-coordinate of the next trough line node point′ᵢ₊₁,

Further, the S5 specifically is as follows:
traversing a time series and analyzing and processing data at each time;
in a case where a horizontal trough exists at a previous time t−1, calculating a north-south longitudinal length YYₜ₋₁ of the horizontal trough based on a difference between y-coordinates of a start point (x₀, y₀) and an end point (xₙ, yₙ) of the horizontal trough at the previous time t−1:

$${YY}_{t - 1} = {( {y}_{0} - {y}_{n} )}_{t - 1} ;$$

calculating a north-south longitudinal length YYₜ₋₁ of a current horizontal trough by calculating a difference between y-coordinates of a start point (x₀, y₀) and an end point (xₙ, yₙ) of a horizontal trough at a current time t:

$${YY}_{t} = {( {y}_{0} - {y}_{n} )}_{t} .$$

Further, the S6 specifically is as follows:
traversing each time point, calculating a relative value of an increase amount ΔYY of a north-south longitudinal length of a horizontal trough at a current time relative to a previous time;

$$Δ YY = ( {YY}_{t} - {YY}_{t - 1} ) / {YY}_{t - 1}$$

in a case where the increase amount ΔYY is greater than a preset growth threshold, judging that a horizontal-to-vertical trough transition occurs, forecasting a strong cold wave weather process, and outputting a start time of the horizontal-to-vertical trough transition; and
otherwise, in a case where all times do not satisfy the judgment condition of the horizontal-to-vertical trough transition, outputting that no horizontal-to-vertical trough transition occurs during the forecast period, and ending the process.

The beneficial effects of the present application are as follows:
(1) The present application is directed to solving the technical problems of how to improve accuracy and timeliness of cold wave prediction, release manual labor, reduce the impact of cold wave disasters on society, and increase automation level. The present application targets cold waves from horizontal-to-vertical trough transition, which have the widest impact and cause the most severe disasters, and achieves automated forecasting through technological innovation.
(2) The present application is based on a 500 hPa geopotential height field, which is most commonly used in meteorological operations, and develops an automatic method for forecasting strong cold waves from horizontal-to-vertical trough transition using wave truncation. The present application belongs to the field of information management for forecasting, prediction and decision-making of large-scale severe meteorological disasters in natural disaster prevention, directly serves emergency management operations, and is directed to safeguarding human life, property, and social security.
(3) The previous cold wave forecasting relied on manual judgment, which not only consumed labor but also lacked sufficient accuracy. The present application proposes an automatic method for identifying cold waves based on observing the horizontal-to-vertical trough transition from meteorological geopotential data, designs corresponding judgment logic according to a definition of the horizontal-to-vertical trough transition occurrence, thereby achieving automatic judgment of cold waves without manual involvement, and greatly improving accuracy.
(4) The present application selects and constructs continuous trough lines from a trough candidate node list, which specifically includes: sorting trough line nodes by height and grouping the nodes; calculating Euclidean distances and angles between trough line nodes; according to an overall principle that trough lines extend westward and southward and that angles approach 180°, prioritizing nodes that are closer and located on the left or below; and ensuring smoothness and continuity of the trough lines through angle optimization. The indexes and coordinates of selected trough line nodes are stored in a fitting line and an index list, and the loop is ended when no suitable point can be found. The method effectively constructs smooth and continuous trough lines, providing reliable data support for terrain analysis and visualization data analysis. The advantage of the present application lies in achieving automatic selection and extraction of continuous trough line nodes through height sorting, distance calculation, and angle optimization, thereby ensuring smoothness and logical consistency of the trough lines. Compared with conventional method relying on manual judgment or simple threshold filtering, this method can more accurately and efficiently identify appropriate trough line nodes, reduce human errors, improve data processing efficiency, and provide more reliable and precise support for terrain analysis and visualization.
(5) The present application determines a minimum position within each closed contour region by traversing contour data and using a convex hull algorithm to detect closed contours, and truncates and reorganizes the trough fitting line node list according to these positions. This method ensures that points within closed regions are orderly and logically consistent during data processing, thereby improving the accuracy and reliability of contour data processing. Compared with conventional method, this method processes closed regions more precisely, reduces manual intervention and errors, ensures continuity and consistency of data processing, and thereby enhances the accuracy and reliability of analysis.

### BRIEF DESCRIPTION OF THE DRAWINGS

FIG. 1 is a schematic diagram of moving cold and warm air in the westerly belt in the background art.

FIG. 2 is a schematic diagram of a horizontal trough A with southward-moving cold air and a vertical trough B with eastward-moving cold air in the background art.

FIG. 3 is a flowchart of the method of the present application.

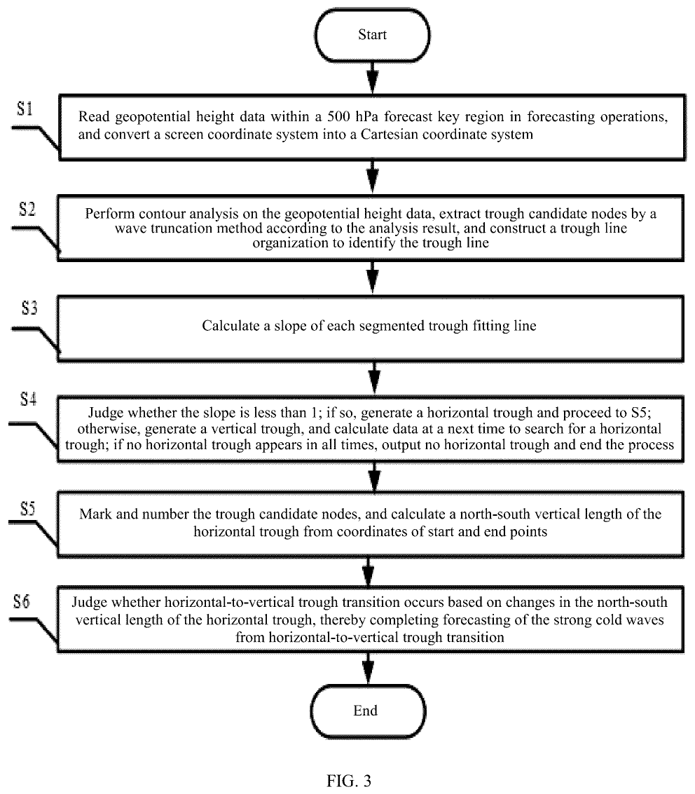

FIG. 4 is a schematic diagram of a Cartesian coordinate system and a screen coordinate system.

FIG. 5 is a schematic diagram of a structure of a list contours.

FIG. 6 is a schematic diagram of a structure of a list all_points.

FIG. 7 is a schematic diagram of a principle of a wave truncation method.

FIG. 8 is a schematic diagram of angles at truncation points.

FIG. 9 is a schematic diagram of trough line organization construction.

FIG. 10 is a schematic diagram of visualization of a trough fitting line at a time t.

FIG. 11 is another schematic diagram of visualization of a trough fitting line at a time t.

FIG. 12 is a schematic diagram of visualization of a trough fitting line at a plurality of time points.

FIG. 13 is a schematic diagram of visualization of a trough fitting line at t=30.

FIG. 14 is a schematic diagram of visualization of the trough fitting line at t=0.

### DESCRIPTION OF EMBODIMENTS

The following description of the specific embodiments of the present application is provided to facilitate the understanding of the present application by those skilled in the art, however, it should be understood that the present application is not limited to the scope of the specific embodiments, and for those of ordinary skill in the art, various changes that are made without departing from the spirit and scope of the present application as defined and determined by the appended claims are apparent, and all inventions and creations that are made by using the concept of the present application are within the protective scope.

### EMBODIMENT

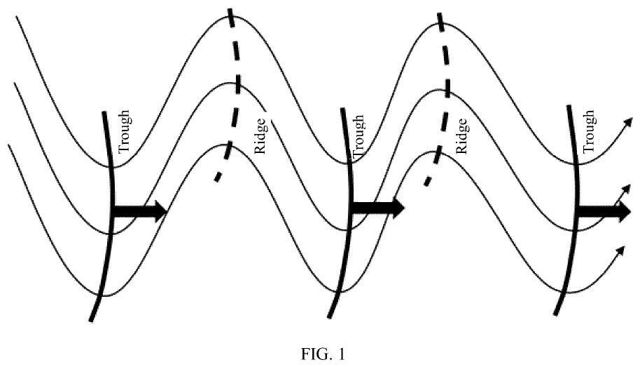

As shown in FIG. 1, the present application provides an automatic method for forecasting strong cold waves from horizontal-to-vertical trough transition using wave truncation, which is implemented by the following steps S1 to S6.

In the S1, geopotential height data within a 500 hPa forecast key region in forecasting operations are read, and a screen coordinate system are converted into a Cartesian coordinate system. The S1 is implemented by the following steps S101 to S103.

In the S101, the geopotential height data within the 500 hPa forecast key region in forecasting operations are read, where the geopotential height data is three-dimensional data, including grid spacing of time interval, latitude, and longitude, and the key region refers to a region from 90°N to 40°N and from 70° E to 140° E.

In the S102, geographic region selection is performed on the read geopotential height data, required latitude and longitude ranges are calculated, and data within a corresponding region are extracted.

In the S103, based on the extracted data within the corresponding region, the screen coordinate system is converted into the Cartesian coordinate system by the following formula:

$$y = height - {y}^{*}$$

where y represents vertical coordinate in the Cartesian coordinate system, height represents a vertical height of the screen coordinate system, and y* represents a vertical coordinate in the screen coordinate system.

In the S2, contour analysis is performed on the geopotential height data, trough candidate nodes are extracted by a wave truncation method according to the analysis result, and a trough line organization is constructed to identify the trough line. Before this step is performed, contour lines need to be plotted based on the geopotential height data, and the main operation is as follows: points having the same geopotential height are connected into lines to visually present the spatial distribution of the height field, and after all points are processed, contour lines are obtained. The S2 is implemented by the following steps S201 to S206.

In the S201, a two-dimensional array data_t is created, contour analysis is performed on the geopotential height data, and the contour line nodes are distributed into a list contours according to elevation levels, where contours represents a list containing all sets of contour line nodes, and the two-dimensional array data_t is configured to store geopotential height data within a range of 90°N-40°N and 70° E-140° E at a time t. The S201 is implemented by the following steps S2011 to S2013.

In the S2011, a maximum geopotential height Hmax0 and a minimum geopotential height Hmin0 are selected within the selected geographic region, where contour analysis is performed on a 500 hPa geopotential height field with 5000 gpm as a reference at intervals of 40 gpm.

In the S2012, the two-dimensional array data_t configured to store geopotential height data within the range of 90°N-40°N and 70° E-140° E at the time t is created.

In the S2013, contour analysis is performed on the two-dimensional array data_t, and the contour line nodes are distributed into the list contours according to elevation levels.

In the S202, each contour line in the list contours is traversed, and the contour line nodes are sequentially stored in a list all_points in a form of triplets, where each contour line includes waves of a plurality of points.

In the S203, truncation points are extracted using a wave truncation method, and the trough candidate nodes are determined by a positive value of vector cross product. The S203 is implemented by the following steps S2031 to S2037.

In the S2031, a straight line is constructed using start and end points of an original multi-wave curve, a distance from each point on the original multi-wave curve to the straight line is calculated, and a point with a maximum distance is taken as a first-level truncation point.

In the S2032, based on the first-level truncation point, an original large multi-wave curve is divided into two shorter sub-curves, start and end points of the two sub-curves are connected to form two new straight lines, a distance from each point of the two sub-curves to a corresponding new straight line is calculated, and a point with a maximum distance is calculated and searched as a second-level truncation point.

In the S2033, the steps S2031 and S2032 are repeated until a maximum distance from points on the sub-curve to the corresponding straight line is less than a preset first distance threshold (the first distance threshold is experimentally determined to be 25 in this application for optimal performance), thereby completing extraction of truncation points.

In the S2034, an order of previous and next points in a truncation point set is defined, a current point is taken as P, a previous point is taken as Pₚᵣₑᵥ, and a next point is taken as Pₙₑₓₜ.

In the S2035, vectors V₁ and V₂ are calculated for the previous and next points according to the defined points.

$${V}_{1} = P - {P}_{prev}$$

$${V}_{2} = {P}_{next} - P$$

In the S2036, a cross product calculation is performed on the two vectors V₁ and V₂;

$${V}_{1} = ( {v}_{1 x} , {v}_{1 y} )$$

$${V}_{2} = ( {v}_{2 x} , {v}_{2 y} )$$

$${V}_{1} \times {V}_{2} = {v}_{1 x} {v}_{2 y} - {v}_{1 y} {v}_{2 x}$$

where v₁ₓ, v_{1y} represents components of the vector V₁ in x and y directions, respectively; and v₂ₓ, v_{2y} represents components of the vector V₂ in x and y directions, respectively.

In the S2037, in a case where the cross product result is positive, the current point is defined as a trough candidate node, thereby judging and identifying the trough candidate node from the truncation point set.

In the S204, a minimum value point in the two-dimensional array data_t is searched and inserted into a trough candidate node list trough_list.

In the S205, based on the trough candidate node list trough_list, the candidate nodes are screened according to an overall principle of the trough line tending westward, southward, and linear, forming the trough node organization, and the trough node organization is constructed into a fitting trough line list fitting_line, for a purpose of constructing trough lines from the trough node organization. The principle for constructing the trough lines is that the trough lines extend westward and southward and tend to be linear with an included angle approaching 180 degrees. The S205 is implemented by the following steps S2051 to S2058.

In the S2051, the trough candidate node list trough_list is sorted according to geopotential height.

In the S2052, trough candidate nodes in the sorted trough candidate node list trough_list are grouped according to contour lines on which the nodes are located, and a grouping result is stored into a list collected_list.

In the S2053, a list now_isotherm_point_index_list configured to store indexes of nodes currently selected to form the trough fitting line is constructed, where an initial value is an index 0 of a first point, that is, a minimum value point in the two-dimensional array data_t.

In the S2054, a list fitting_line configured to store the selected trough line nodes is constructed in the form of a dictionary.

In the S2055, each contour line in the list collected_list is sequentially traversed, empty lists each_contour_distance_list and angle_list are created for each contour line in collected_list starting from index 1, a last node in the current trough fitting line is taken as start_point, trough candidate nodes in each contour line are traversed, and a Euclidean distance distance between each trough candidate node in a current contour and the last node start_point in the current trough fitting line is calculated:

$$distance = \sqrt{{( x - {x}_{0} )}^{2} + {( y - {y}_{0} )}^{2}}$$

where x₀ represents x-coordinate of a node each_point in the current contour, y₀ represents y-coordinate of the node each_point in the current contour, x represents x-coordinate of a node start_point in the current trough fitting line, y represents y-coordinate of the node start_point in the current trough fitting line, and both the node each_point and the node start_point are trough candidate nodes.

In the S2056, a position of the node each_point relative to the node start_point is determined by the following formula:

$$dx = each \_ point \_ x - st art \_ point \_ x$$

$$dy = e ach \_ point \_ y - start \_ point \_ y$$

where dx and represent positions of the node each_point relative to the node start_point, each_point_x and each_point_y represent an x-coordinate and a y-coordinate of the node each_point, respectively, and start_point_x and start_point_y represent an x-coordinate and a y-coordinate of the node start_point, respectively; and the node each_point represents a trough candidate node being examined one by one in the list collected_list, and the trough candidate node being currently examined is taken as the node each_point.

In the S2057, in a case where dx<0, that is, the node each_point is on the left side of the node start_point, and a number of points currently selected to form the trough fitting line stored in the list now_isotherm_point_index_list is greater than or equal to 2, angles among the current node each_point and last two nodes in the list now_isotherm_point_index_list are calculated, where the last two nodes for calculation are the most recently selected nodes stored in the list now_isotherm_point_index_list forming the trough fitting line, and the angles among the three nodes into the list angle_list are stored, where the three nodes includes the current node and the last two nodes, and the angles are formed by the current node each_point and the last two nodes in the list now_isotherm_point_index_list, with the last node in the list now_isotherm_point_index_list located at the center;

in a case where dx<0, that is, the node each_point is on the left side of the node start_point, and dy>0, that is, the node each_point is above the node start_point, a distance between the node each_point and the node start_point is calculated, and the distance between the node each_point and the node start_point is added to the list each_contour_distance_list; otherwise, the distance between the node each_point and the node start_point is multiplied by a second distance threshold, and a result of multiplication is added to the list each_contour_distance_list; and

in a case where dx>0, that is, the node each_point is on the right side of the node start_point, a distance is set to 99999 according to meteorological business specifications, and the distance is added to the list each_contour_distance_list; and an angle is set to 90°, and the angle is added to the list angle_list.

Since trough line nodes with different contour serial numbers originate from different contour lines, and different contour lines do not intersect with each other, coordinates of the trough line nodes are not equal in either x or y direction, that is, a case where dx=0 does not exist.

In the S2058, the three cases of S2057 are screened to obtain the fitting trough line list fitting_line. The S2058 is implemented by the following steps S20581 to S20586.

In the S20581, a trough candidate node in the current contour that is closest to the node start_point is searched, and an index of a minimum distance is recorded as minize_index:

$$minize \_ index = {\underbrace{argmin}}_{{i}^{′}} \{ distance ( {point}_{i} , start \_ point ) \}$$

where minize_index represents the index of the minimum distance, argmin represents an index that minimizes an objective function distance (pointᵢ, start_point), point represents a trough candidate node in the current contour currently being used to calculate the distance to the node start_point, and i′ represents an index of the trough candidate node in the current contour that is closest to the node start_point.

In the S20582, a difference angle_diff_{[j]} between each angle in the list angle_list and 180° is calculated:

$${angle \_ diff}_{[ j ]} = \vert {angle \_ list}_{[ j ]} - {180}^{°} \vert$$

where angle_list_{[j]} represents a list used for recording and storing angles angle among three nodes, including a current trough candidate node j and the last two nodes in the list of the most recently selected nodes forming the trough fitting line.

S20583. in a case where |angle_list|≥2 and |now_isotherm_point_index_list|≥3 then

$$nearest \_ flatten \_ angle \_ index = {\underbrace{argmin}}_{{i}^{′}} \{ {angle \_ diff}_{[ j ]} \} ;$$

where |angle_list|≥2 represents that the number of angles existing in the list angle_list is greater than 2, |now_isotherm_point_index_list|≥3 represents that the number of points existing in the list now_isotherm_point_index_list is greater than 3, and

$$nearest \_ flatten \_ angle \_ index = {\underbrace{argmin}}_{{i}^{′}} \{ {angle \_ diff}_{[ j ]} \}$$

represents updating the index nearest_flatten_angle_index to point to a trough candidate node whose an included angle with a previous trough fitting line is closest to 180°.

In the S20584, whether the index nearest_flatten_angle_index is inconsistent with the index minize_index is compared; in a case where nearest_flatten_angle_index≠minize_index, and each_contour_distance_list[nearest_flatten_angle_index] is less than or equal to a preset first threshold, the index minize_index is updated to the index nearest_flatten_angle_index.

In the S20585, coordinates of a node in the current contour line that satisfies a fitting condition of a trough fitting line are added to the fitting trough line list fitting_line, and an index of the node is added to the list now_isotherm_point_index_list; count is updated by increasing the number of the currently selected nodes forming the trough fitting line by one, and the next traversal is performed; in a case where a length of the list each_contour_distance_list is 1 and the value exceeds a set second threshold, it indicates that only one point exists in the current contour line and the distance is the maximum, the loop is ended and the extension of the trough line is stopped, where count represents a total number of currently selected nodes forming the trough fitting line, and the node satisfying the fitting condition of the trough fitting line corresponds to the index minize_index.

In the S20586, information of trough candidate nodes corresponding to all indexes in the list now_isotherm_point_index_list is stored into the list contours_list_with_line, so as to complete the fitting of the trough line.

In the S206, whether a closed contour exists is judged using a convex hull algorithm, if so, a minimum position of a region of the closed contour is searched, a trough line node list is reorganized, and the identification of the trough line is completed. The S206 specifically is as follows:
calculating a distance between a start_point and an end point of each contour line;
in a case where the distance is less than a preset third threshold, judging that a point set array contour_data is approximately closed; or
in a case where the distance is equal to the preset third threshold, judging that the point set array contour_data is approximately closed;
storing minimum positions of regions of all closed contour lines into a list closed_min_list;
truncating a trough fitting line node list contours_list_with_line into a plurality of sublists according to the minimum positions of the closed regions; and
inserting a minimum position of each closed region at the beginning of each sublist, sorting the trough fitting line node list contours_list_with_line according to height values, and updating a fitting trough line list fitting_line.

In the S3, a slope of each segmented trough fitting line is calculated. The S3 is implemented by the following steps:
S301. analyzing a list contours_list_with_line to judge whether the list includes segmented sublists; if so, proceeding to step S303; otherwise, proceeding to step S302;
S302. calculating slopes between trough line nodes, obtaining an average value of the slopes, taking the average value as a characteristic slope of the trough line, and storing the slope of the trough fitting line:

$$slope = \frac{1}{{n}^{′}} {\sum }_{{i}^{″} = 0}^{{n}^{′} - 1} {slpoe}_{-} list [ i ]$$

$${slpoe}_{-} list [ i ] = \frac{{y}_{i + 1} - {y}_{i}}{{x}_{i + 1} - {x}_{i}}$$

where slope represents the characteristic slope of the trough line, n′ represents the number of data in the list slope_list, i″ represents an index of data in the list slope_list, and slpoe_list[i] represents slopes between each trough line node point′ᵢ and a next trough line node point′ᵢ₊₁ thereof; and
S303. sequentially traversing the trough line nodes in each segmented sublist, calculating slopes between the trough line nodes in each segmented sublist, obtaining an average value of the slopes as an average slope of each segmented sublist, performing an averaging process on the average slopes of all the segmented sublists to obtain a slope of a trough fitting line of all the segmented sublists, and storing the slope of the trough fitting line of all the segmented sublists:

$$slope = \frac{1}{m} {\sum }_{{j}^{′} = 0}^{m - 1} mean \_ slope {\_ j}^{′} [ j ]$$

$$mean \_ slope {\_ j}^{′} [ j ] = \frac{1}{{n}_{{j}^{′}}} {\sum }_{{i}^{″} = 0}^{{nj}^{′} - 1} {slope \_ list}_{-} j [ i ]$$

$${slope \_ list}_{-} j [ i ] = \frac{{y}_{i + 1} - {y}_{i}}{{x}_{i + 1} - {x}_{i}}$$

where slope represents the slope of the trough fitting line of all the segmented sublists, m represents the number of data in the list mean_slope_j′, j′ represents an index of data in the list mean_slope_j′, mean_slope_j′[j] represents a list of average slopes of the trough fitting lines of each segmented sublist, n_{j′} represents the number of data in the list slope_list_j[i], i″ represents an index of data in the list slope_list_j, slope_list_j[i] represents a list of slopes of straight lines between each trough line node point′ᵢ and a next trough line node point′ᵢ₊₁ in each segmented sublist sublistⱼ, xᵢ and yᵢ represent an x-coordinate and a y-coordinate of the trough line node point′ᵢ, respectively, and xᵢ₊₁ and yᵢ₊₁ represent an x-coordinate and a y-coordinate of the next trough line node pointᵢ₊₁.

In the S4, whether the slope is less than 1 is judged; if so, a horizontal trough is generated and S5 is performed; otherwise, a vertical trough is generated, and data at a next time is calculated to search for a horizontal trough; if no horizontal trough appears in all times, no horizontal trough is output and the process is ended.

In the S5, the trough candidate nodes are marked and numbered, and a north-south vertical length of the horizontal trough is calculated from coordinates of start and end points. The S5 is specifically as follows:
traversing a time series and analyzing and processing data at each time;
in a case where a horizontal trough exists at a previous time t−1, calculating a north-south longitudinal length YYₜ₋₁ of the horizontal trough based on a difference between y-coordinates of a start point (x₀, y₀) and an end point of the horizontal trough at the previous time t−1:

$${YY}_{t - 1} = {( {y}_{0} - {y}_{n} )}_{t - 1}$$

calculating a north-south longitudinal length YYₜ₋₁ of a horizontal trough by calculating a difference between y-coordinates of a start point (x₀, y₀) and an end point (xₙ, yₙ) of a horizontal trough at a current time t:

$${YY}_{t} = {( {y}_{0} - {y}_{n} )}_{t} .$$

In the S6, whether horizontal-to-vertical trough transition occurs is judged based on changes in the north-south vertical length of the horizontal trough, thereby completing forecasting of the strong cold waves from horizontal-to-vertical trough transition. The S6 is specifically as follows:
traversing each time point, calculating a relative value of an increase amount ΔYY of a north-south longitudinal length of a horizontal trough at a current time relative to a previous time;

$$Δ YY = ( {YY}_{t} - {YY}_{t - 1} ) / {YY}_{t - 1}$$

in a case where the increase amount ΔYY is greater than a preset growth threshold (the growth threshold is experimentally determined to be 0.1 in this application for optimal performance), judging that a horizontal-to-vertical trough transition occurs, forecasting a strong cold wave weather process, and outputting a start time of the horizontal-to-vertical trough transition; and
otherwise, in a case where all times do not satisfy the judgment condition of the horizontal-to-vertical trough transition, outputting that no horizontal-to-vertical trough transition occurs during the forecast period, and ending the process.

In this embodiment, input data of the present application is geopotential height data with high temporal and spatial resolution (unit: m²/s² or geopotential meter, abbreviated as gpm), where the geopotential height data is stored in a three-dimensional array arranged in an order of time, latitude, and longitude (illustrated using the data file z_2020.12.27-30 as an example). The time interval is 1 hour (ranging from 2020.12.27T0:00:00 to 2020.12.30T23:00:00) including 144 hours, i.e., 6 days, after a forecast time. The latitude grid spacing is 0.25 degrees, ranging from 90°N to 90° S, with a total of 721 latitude points from the North Pole to the South Pole. The longitude grid spacing is 0.25 degrees, ranging from 0° to 360°, circling the Earth eastward from the Prime Meridian, where 0° and 360° represent the same point, with a total of 1440 longitude points. Therefore, the three-dimensional data organization is 96×721×1440. The three-dimensional array represents temporal variations and spatial distribution of geopotential height in the atmosphere. The read geopotential height data is stored in an array data in a floating-point format.

In this embodiment, a source region of upper-level cold air affecting the strong cold waves from horizontal-to-vertical trough transition is located in Siberia, i.e., a region north of China. Therefore, a region for locating an initial horizontal trough is set within a range from 90°N to 40°N latitude and from 70° E to 140° E longitude. Based on this, a geographic region selection is performed on the read array data. The specific calculation is as follows:

### Latitude Calculation:

The starting latitude of 90°N corresponds to row 0. A row number n₁ corresponding to the ending latitude of 40°N can be calculated by the following formula:

$${n}_{1} = \frac{90 ° - {n}_{2}}{0.25 °}$$

n₂ represents a target latitude.

A value of 40 is substituted for 40° N:

$${n}_{3} = \frac{90 ° - 40 °}{0.25 °} = 200$$

n₃ represents an ending row number.

Therefore, the latitude range extends from row 0 to row 200, with a total of 201 rows.

### Longitude Calculation:

The starting longitude of 70° E corresponds to a column number n₄, which can be calculated by the following formula:

$${n}_{4} = \frac{{n}_{5}}{0.25 °}$$

n₅ represents a target longitude.

A value of 70 is substituted for 70° E:

$${n}_{6} = \frac{70 °}{0.25 °}$$

n₆ represents an initial column number.

The ending longitude of 140° E corresponds to an ending column number n₇, which can be calculated using the same formula:

$${n}_{7} = \frac{140 °}{0.25 °} = 560.$$

Therefore, the longitude range extends from column 280 to column 560, with a total of 281 columns.

Data in rows 0 to 200 of the second dimension (latitude) and columns 280 to 560 of the third dimension (longitude) in the array data, corresponding to a total of 201 latitude rows and 281 longitude columns, is extracted to obtain data within the required geographic region.

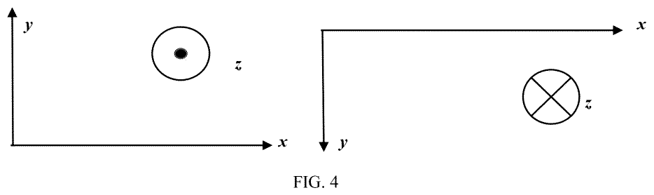

In this embodiment, a conventional coordinate system is a Cartesian plane rectangular coordinate system, where a horizontal axis pointing to the right is defined as a positive x-direction, and a vertical axis pointing upward is defined as a positive y-direction. On a computer display screen, the horizontal x-axis is defined the same as in the Cartesian plane rectangular coordinate system, but the vertical y-axis is opposite to the Cartesian plane definition, with a positive y-direction pointing from top to bottom. Such a difference generates a contradiction during vector operations. For example, in the conventional Cartesian plane rectangular coordinate system, in a case where the x-axis vector is cross-multiplied with the y-axis vector following the right-hand rule, a resulting z vector is positive and points outward from the screen. In the screen coordinate system, following the same right-hand rule, the resulting z vector is negative and points into the screen (as shown in FIG. 4). To resolve this contradiction, the conventional mathematical representation is used in subsequent analysis, and the screen coordinates are converted to Cartesian coordinates.

Since horizontal coordinates x are identical in both systems, no transformation is performed for x. The vertical coordinate y* in the screen coordinate system is converted to y in the Cartesian coordinate system. When a vertical height of the screen is height, the conversion formula is:

$$y = height - {y}^{*}$$

where y represents vertical coordinate in the Cartesian coordinate system, height represents a vertical height of the screen, and y* represents a vertical coordinate in the screen coordinate system.

After the above transformation, the screen coordinate system is converted into the Cartesian coordinate system, ensuring that subsequent operations can be expressed mathematically in a conventional manner.

In this embodiment, a two-dimensional array data_t is created to store geopotential height data, i.e., elevations, within a range of 90°N-40°N latitude and 70° E-140° E longitude at a time t, for performing contour analysis.

First, a maximum geopotential height Hmax0 and a minimum geopotential height Hmin0 are selected within the selected region. The contour analysis is performed on a 500 hPa geopotential height field with 5000 gpm as a reference at intervals of 40 gpm.

Subsequently, contour lines are analyzed for the two-dimensional array data_t, and nodes on each contour line are stored in a list contours. The contours list is a nested list containing all node sets of all contour lines, where each contour line set is itself a list containing all nodes of the contour line. A length of contours corresponds to the number of contour height levels.

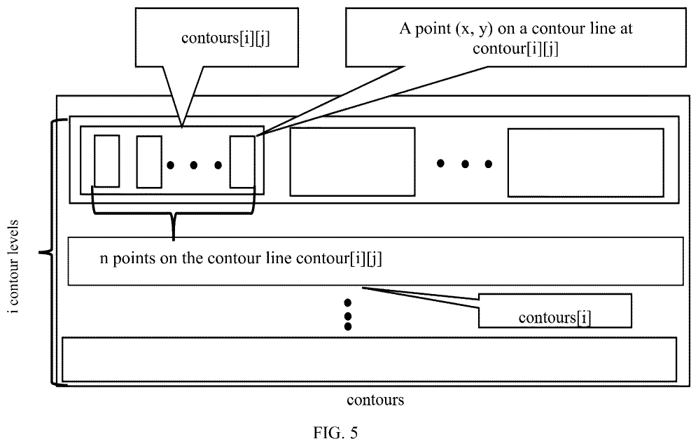

Specifically, contours[i] is a list containing points of a contour line corresponding to the i-th contour height level; contours[i][j] is a NumPy array representing nodes on the j-th contour line at the i-th contour level; each NumPy array has a shape of (n, 2), where n represents n nodes on contours[i][j], and 2 represents coordinates (x, y) of each point on the contour line, i.e., longitude and latitude of each point. As shown in FIG. 5, this corresponds to i contour levels.

According to this method, a geopotential height distribution in the region of interest can be represented, facilitating subsequent analysis and determination of the occurrence and development of cold wave. This processing method improves data readability and intuitiveness, providing support for further meteorological analysis and forecasting.

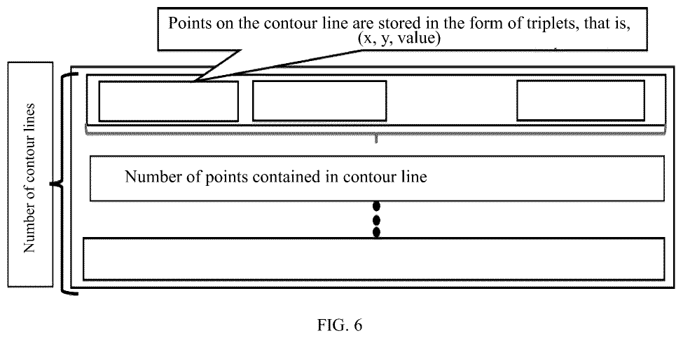

From the obtained contour node data contours, each contour line in every contour set is traversed sequentially according to the contour values, i.e., elevation levels, and the nodes of the contour line are added to a list all_points. The all_points structure is a list, where each element is a list containing a plurality of points. Each point on a contour line is stored in a form of a triplet (x, y, value), representing the x and y coordinates of the point and a value from the two-dimensional array data_t used to store geopotential height data, thereby achieving extraction of contour node data. The value represents geopotential height at the point, as shown in FIG. 6, which illustrates the number of contour lines and the number of points contained on each contour line. By this method, contour point data can be systematically managed and processed in a standardized and orderly manner, improving efficiency and accuracy of data handling. This processing method not only enables precise extraction of contour point data, but also optimizes the data structure, providing a reliable data basis for further analysis, computation, and visualization.

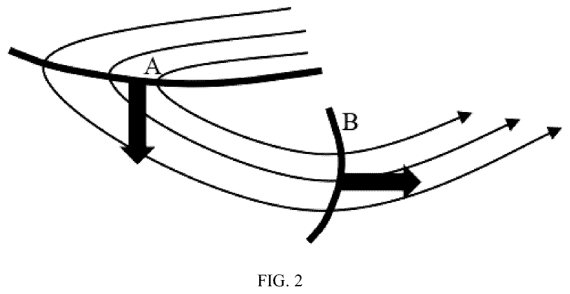

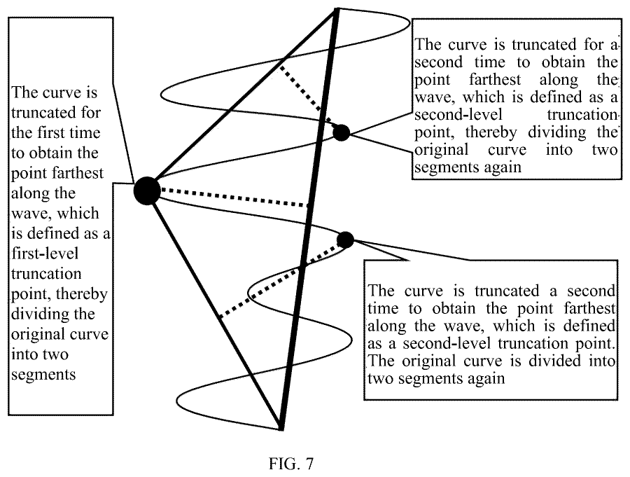

In this embodiment, at upper levels, contour lines of the geopotential height field coincide with airflow, appearing as undulating curves. Therefore, wave of airflow in FIGS. 1 and 2 also represent waves of the geopotential height contour lines. This application adopts a wave truncation method for analysis, in which a plurality of continuous waves are successively decomposed into smaller waves until the simplest wave is obtained. For a contour line to be analyzed, a plurality of waves on the contour line are continuously truncated and subdivided. The analysis principle is shown in FIG. 7. The wave truncation method repeatedly truncates waves until all waves are decomposed. In FIG. 7, the entire original curve is first connected at endpoints as a thick line, and a first-level truncation point is calculated and marked with a large dot. In this step, the original curve is divided into two segments, with endpoints of each segment connected by thinner lines, and second-level truncation points are calculated and marked with small dots. This process is repeated to complete decomposition of all waves, obtaining a plurality of truncation points, which represent points of strongest wave amplitude. As shown in the figure, the first truncation identifies the farthest point on the wave as a first-level truncation point, dividing the original curve into two segments; the second truncation identifies the farthest point on the wave again as a second-level truncation point, further dividing the original curve into two segments.

In this embodiment, first, a straight line is drawn connecting the start and end points of an original multi-wave curve, and distances from each point on the original wave curve to this straight line are calculated. A point with the maximum distance represents a location of strongest wave and is taken as a truncation point. At this step, the original multi-wave curve is divided into two shorter sub-curves. Subsequently, start and end points of the two sub-curves are connected to form two new straight lines, and distances from points on each sub-curve to the corresponding straight line are calculated to identify points with the maximum distances as second-level truncation points. Further, each curve is again divided at these truncation points to obtain even shorter sub-curves. By repeatedly performing this process, the original complex waves are gradually decomposed, resulting in a series of truncation points. All of these truncation points represent locations of strongest wave within each segment of the curve. After the truncation points are obtained, properties of these truncation points are determined to judge whether the truncation points constitute trough candidate nodes.

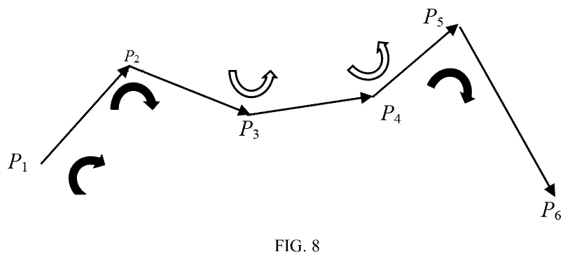

In this embodiment, an angle at a truncation point is defined as an angle between two adjacent line segments intersecting at the point. As shown in FIG. 8, P₁, P₂, P₃, P₄, P₃, P₆ represent truncation points, and the angle at truncation point 2 is the angle between vector P₁P₂ and vector P₂P₃. A counterclockwise (CCW) rule is adopted to determine the sign of the angle. As shown in FIG. 8, in a case where P₁, P₂, P₃ is in a clockwise order, the angle at truncation point P₂ is negative (as indicated by the solid arrow); in a case where P₃, P₄, P₅ is in a counterclockwise order, the angle at truncation point P₄ is positive (as indicated by the hollow arrow). According to the angle sign determination rule (CCW) and in combination with ridge and trough attributes, a positive angle corresponds to a trough candidate node (as shown in FIG. 8, P₃, P₄)

The present application creates a class function according to the above method to achieve extraction of trough candidate nodes from contour lines. An initialization method of the class requires a contour line set as input, specifically a list of point arrays all_points and a specified contour interval. The output is a list for storing the extracted trough candidate nodes. A core aspect of the class is to reduce the number of points in a given curve, improving efficiency while retaining the original shape as much as possible. The specific implementation includes the following steps:
1. Each contour line in the contour line set is sequentially traversed, where each contour line contains a plurality of waves.
2. Distances are calculated. A point in the wave farthest from a straight line connecting the start and end points, i.e., the point of strongest wave, is selected as a truncation point within the current wave range.
3. At the truncation point, the current longer wave is divided into two shorter waves.
4. Steps 2 and 3 are repeated to calculate distances and continuously truncate waves, gradually decomposing longer waves. Each contour line is recursively divided until distances of points are below a first distance threshold, which is experimentally determined in the present application to be 25 for optimal performance. The recursion terminates when a farthest truncation point has a distance smaller than the first distance threshold (25), and a list of truncation points for each contour line is returned.
5. Truncation points are recorded, and, according to geometric relationships of the truncation points, it is determined whether each point is a trough candidate node:

Vectors around each characteristic point are calculated, and a cross product of the vectors is used to determine the angle relationship, thereby identifying whether the point is a trough candidate node. The steps are as follows:

### 1) Definition of Previous and Next Points:

A current point is taken as P, a previous point is taken as Pₚᵣₑᵥ and a next point is taken as Pₙₑₓₜ.

2) Calculation of the Vectors V₁ and V₂:

$${V}_{1} = P - {P}_{prev}$$

$${V}_{2} = {P}_{next} - P$$

### 3) Cross Product of the Two Vectors:

$${V}_{1} = ( {v}_{1 x} , {v}_{1 y} )$$

$${V}_{2} = ( {v}_{2 x} , {v}_{2 y} )$$

$${V}_{1} \times {V}_{2} = {v}_{1 x} {v}_{2 y} - {v}_{1 y} {v}_{2 x}$$

where v₁ₓ, v_{1y} represents components of the vector V₁ in x and y directions, respectively; and v₂ₓ, v_{2y} represents components of the vector V₂ in x and y directions, respectively.

### 4) Judgment of Properties of the Characteristic Points:

In a case where the cross product is positive, then:

$${V}_{1} \times {V}_{2} > 0$$

representing a leftward rotation of the airflow, corresponding to a trough node, P₃, P₄ as shown in FIG. 8,
   6. According to the result of the cross product and the above determination rules, truncation points obtained by the wave truncation method are judged as to whether the truncation points are trough candidate nodes, added to an empty list, and the extracted trough candidate node list is returned for further analysis.

In this embodiment, a global minimum point is searched and inserted into a trough candidate node list to form a new trough candidate node list.

An index of the minimum value is searched from the multidimensional array data_t used to store geopotential height data. The index is converted to corresponding coordinates in the multidimensional array data_t using a flat index conversion method, and this minimum value point (global lowest point) is inserted at the beginning of the list trough_list as a new node. Since a trough line starts from the global minimum geopotential height, a trough candidate node list trough_list is thereby formed.

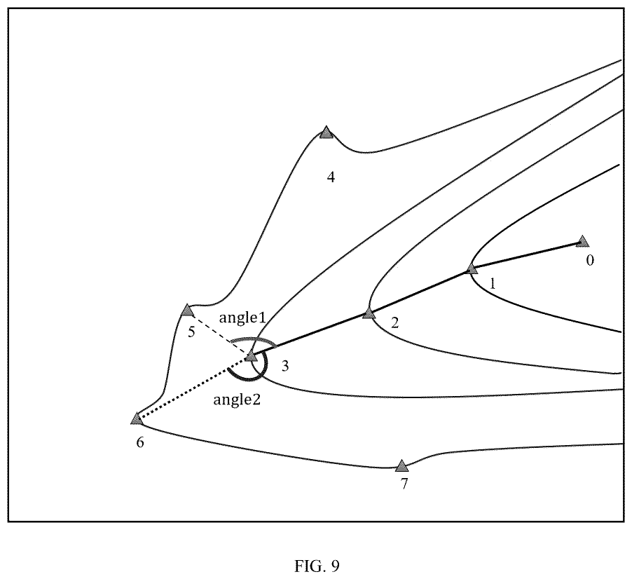

In this embodiment, as shown in FIGS. 1 and 2, a trough line crosses different contour lines. After the trough candidate nodes are extracted from each contour line, these nodes exhibit a complex spatial distribution. As shown in FIG. 9, FIG. 9 is a schematic diagram of trough line organization construction, representing a position of a trough candidate node each_point relative to a last node start_point in the current trough fitting line. Attention is drawn to the complex relationships among trough nodes 3, 4, 5, 6, and 7. Organizational rules must be established to correctly represent the trough line. In the figure, a current node (nodes 5 and 6) and the last two nodes (nodes 2 and 3) stored in the node array of the currently selected trough fitting lines form three nodes, and the angles (specifically angle 1 and angle 2) among the three nodes is calculated, which is stored in the list angle_list.

In meteorology, a trough line extends from contour lines with lower geopotential heights to contour lines with higher geopotential heights, or from lower elevations to higher elevations. In general, the trough line is organized and constructed according to a principle of extending westward, southward, and tending to be linear.

Therefore, the obtained trough candidate node list trough_list is first sorted according to the third element of each point, namely the geopotential height, so as to enable rapid positioning and processing of trough nodes with specific height characteristics during complex topographic analysis, thereby providing an efficient data access structure for subsequent processing. Then, in the sorted list trough_list, that is, from a series of contour line data, a comprehensive analysis based on distance and angle is performed as follows: starting from the current node, the most suitable node in the next contour line with a higher geopotential height is selected, thereby screening and identifying the trough nodes that can form a trough line. The specific steps are as follows:

First, the sorted list trough_list is grouped according to the range of contour values. The trough candidate nodes are grouped within specific contour ranges. The trough candidate node list trough_list is traversed, and whether the value of each node falls within a given contour range is determined. A group list containing nodes belonging to adjacent contour lines is gradually constructed, that is, the trough candidate nodes in the sorted list trough_list are grouped according to the contour lines to which the trough candidate nodes belong. The result of this step is stored in the list collected_list to facilitate further analytical processing. The count is used as an index accumulator. A list now_isotherm_point_index_list is established to store the indexes of currently selected trough nodes that form the trough fitting line, and the initial value is set to the index 0 corresponding to the first point, namely the global minimum point. The list fitting_line is used to store the selected trough line nodes (nodes forming the trough fitting line) in a dictionary form, where count serves as a key, and the first point is used as an initial value. Each contour line in the list collected_list is sequentially traversed. Starting from index 1, each contour line in the list collected_list is processed, and the empty lists each_contour_distance_list and an empty list angle_list are created. The last node in the current trough fitting line is set as start_point. Each point in the contour line is traversed, and the Euclidean distance between each current trough candidate node and start_point is calculated:

$$distance = \sqrt{{( x - {x}_{0} )}^{2} + {( y - {y}_{0} )}^{2}}$$

where x₀ represents x-coordinate of a trough candidate node each_point in the current contour, y₀ represents y-coordinate of the trough candidate node each_point in the current contour, x represents x-coordinate of a node start_point in the current trough fitting line, y represents y-coordinate of the node start_point in the current trough fitting line.

The position of the node each_point relative to the node start_point is determined:

$$d x = each\_point \_x - start\_point \_x$$

$$dy = each\_point \_y - start\_point \_y$$

where the node each_point represents a trough candidate node being examined one by one in the list collected_list, and the node being currently examined is taken as the node each_point; dx and dy represent positions of the node each_point relative to the node start_point, each_point_x and each_point_y represent an x-coordinate and a y-coordinate of the node each_point, respectively, and start_point_x and start_point_y represent an x-coordinate and a y-coordinate of the node start_point, respectively. As shown in FIG. 9, node 3 serves as start_point, and nodes 4, 5, 6, and 7 serve as each_point, respectively.

It can be seen that extending the trough line from node 0 to node 3 is relatively simple and easily organized, whereas extending and organizing the trough line from node 3 onward is relatively complex and divided into three cases.

Case A1: In a case where dx<0, that is, the node each_point is on the left side of the node start_point, and a number of points currently selected to form the trough fitting line stored in the list now_isotherm_point_index_list is greater than or equal to 2, (as shown by nodes 5 and 6 in FIG. 9), the angles angle among three points are calculated, where the three points include the current node each_point and the last two nodes in the list now_isotherm_point_index_list, the last two nodes are the most recently selected nodes stored in now_isotherm_point_index_list that form the trough fitting line, and the calculated angles are stored in the list angle_list (as shown by angle 1 and angle 2 in FIG. 9). The specific steps are as follows:

A1-1. A vector is defined:

$${V}_{1} = {p}_{2} - {p}_{1}$$

$${V}_{2} = {p}_{3} - {p}_{2}$$

where p₁, p₂ and p₃ respectively represent node each_point, node start_point, and the second-to-last node most recently selected in the list now_isotherm_point_index_list that forms the trough fitting line.

A1-2. A dot product of the vectors is calculated.

$${V}_{1} \cdot {V}_{2} = ( {x}_{1} - {x}_{2} ) \cdot ( {x}_{3} - {x}_{2} ) + ( {y}_{1} - {y}_{2} ) \cdot ( {y}_{3} - {y}_{2} )$$

where (x₁, y₁), (x₂, y₂) and (x₃, y₃) respectively represent the coordinates of node p₁, node p₂, and node p₃.

A1-3. A magnitude of the vectors is calculated.

$$\vert {V}_{1} \vert = \sqrt{{( {x}_{1} - {x}_{2} )}^{2} + {( {y}_{1} - {y}_{2} )}^{2}}$$

$$\vert {V}_{2} \vert = \sqrt{{( {x}_{3} - {x}_{2} )}^{2} + {( {y}_{3} - {y}_{2} )}^{2}}$$

A1-4. A cosine value of the angle cos θ is calculated.

$$cos θ = \frac{{V}_{1} \cdot {V}_{2}}{⌈ {V}_{1} ⌉ \cdot ⌈ {V}_{2} ⌉} .$$

A1-5. Conversion between the angle in radians and degrees is performed.

$$angle = \frac{180 °}{π} arccos ( cos θ )$$

Case A2: In a case where dx<0, that is, the node each_point is on the left side of the node start_point, and dy>0, that is, the node each_point is above the node start_point, a distance between the node each_point and the node start_point is calculated and added to the list each_contour_distance_list (as shown by node 5 in FIG. 9); otherwise, the distance is multiplied by 0.7 (the second threshold is experimentally determined to be 0.7 in this application for optimal performance, as shown by node 6 in FIG. 9) and then added to the list each_contour_distance_list.

Case A3: In a case where dx>0, that is, the node each_point is on the right side of the node start_point, a distance is set to 99999 and the angle is set to 90° in accordance with meteorological operational specifications (as shown by nodes 4 and 7 in FIG. 9).

According to the characteristics of the trough line, only one trough line node is selected on a single contour line. Therefore, in the selection of trough line nodes, the stored data is screened based on the three cases described above, where the most easterly node is first removed because this node does not conform to meteorological principles. The specific steps are as follows:

B1. A trough candidate node closest to the node start_point on the current contour line is identified, and an index of the minimum distance is recorded as minize_index (as shown in FIG. 9, node 5 is the point closest to node 3, so minize_index corresponds to node 5).

$$minize\_index = \underbrace{argmin}_{{i}^{′}} \{ distance ( {point}_{i} , start\_point ) \}$$

where minize_index represents the index of the minimum distance, argmin represents an index that minimizes an objective function distance (pointᵢ, start_point), pointᵢ represents a trough candidate node in the current contour currently being used to calculate the distance to start_point, and i′ represents an index of the trough candidate node in the current contour that is closest to the node start_point.

B2. A difference between each angle in the list angle_list and 180 degrees is calculated and denoted as angle_diff_{[j]}:

$${angle\_diff}_{[ j ]} = \vert {angle\_list}_{[ j ]} - 180 ° \vert$$

where angle_list_{[j]} represents a list used for recording and storing angles angle among three nodes, including a current trough candidate node j and the last two nodes in the list of the most recently selected nodes forming the trough fitting line.

B3. In a case where |angle_list|≥2 and |now_isotherm_point_index_list|≥3, then

$$nearest\_flatten \_angle \_index = \underbrace{argmin}_{{i}^{′}} \{ {angle\_diff}_{[ j ]} \} ;$$

where |angle_list|≥2 represents that at least two angles exist in the list angle_list. In general, the overall curvature of the trough line system is small, being close to a straight line, or in other words, the angles formed by adjacent points are close to 180°.

|now_isotherm_point_index_list|≥3 represents that at least three points exist in the list now_isotherm_point_index_list, and

$$nearest\_flatten \_angle \_index = \underbrace{argmin}_{{i}^{′}} \{ {angle\_diff}_{[ j ]} \}$$

represents that the index nearest_flatten_angle_index is updated to point to the node whose angle with the previous trough fitting line is closest to 180°. That is, the index corresponding to the smallest value in angle_diff[j] is selected (as shown in FIG. 9, node 6 forms an angle with the previous trough fitting line closer to 180° than node 5, so nearest_flatten_angle_index corresponds to node 6).

B4. A comparison is made between the index nearest_flatten_angle_index and the index minize_index to determine whether these indexes are inconsistent. In a case where nearest_flatten_angle_index≠minize_index, and each_contour_distance_list[nearest_flatten_angle_index] is less than or equal to a preset first threshold (the first threshold being 90), minize_index=nearest_flatten_angle_index. This formula indicates that if the index nearest_flatten_angle_index differs from the index minize_index, and the distance of the point corresponding to nearest_flatten_angle_index in the list each_contour_distance_list is less than or equal to 90 (the first threshold), then minize_index is updated to nearest_flatten_angle_index (as shown in FIG. 9, nearest_flatten_angle_index corresponds to node 6, which differs from minize_index corresponding to node 5, so minize_index is updated to node 6, that is, node 6 is selected as the point on the current contour line most suitable for forming the trough fitting line). The purpose of this operation is to progressively select a more suitable node from a set of nodes. Considering the distance and angle of the nodes, preference is given to points that are closer and located nearby or to the left (westward), thereby constructing a smooth and logically coherent trough fitting line for further analysis.

B5. Coordinates of a node in the current contour line that satisfies a fitting condition of a trough fitting line are added to the fitting trough line list fitting_line, and an index of the node is added to the list now_isotherm_point_index_list; count is updated by increasing the number of the currently selected nodes forming the trough fitting line by one, and the next traversal is performed. In a case where a length of the each_contour_distance_list is 1 and the value exceeds a set second threshold (the second threshold is 100), it indicates that only one point exists in the current contour line and the distance is the maximum, the loop is ended and the extension of the trough line is stopped.

$$fitting\_line ← fitting\_line ⋃ \{ current\_point \}$$

$$now\_isotherm \_point \_index \_list ← now\_isotherm \_point \_index \_list ⋃ \{ cuttent\_point \_index \}$$

$$count = count + 1$$

where current_point represents the coordinates of the node on the current contour line most suitable for forming the trough fitting line, current_point_index represents the index of the node on the current contour line most suitable for forming the trough fitting line, and count represents the total number of nodes already selected to form the trough fitting line.

B6. Information of trough candidate nodes corresponding to all indexes in the list now_isotherm_point_index_list is stored into the list contours_list_with_line.

In this embodiment, a special case occurs when a closed contour line exists, in which case the minimum position of the closed contour line region is identified, and the filtered trough line node list is reorganized.

For this situation, each contour line in the point set array contour_data is sequentially traversed to determine whether a closed contour line exists. A convex hull (ConvexHull) algorithm, which is a mature and fundamental algorithm in computational geometry, is used to determine the outermost structure of the point set, and this algorithm is used to identify the smallest convex polygon capable of enclosing all points in the set. In this application, a distance between the start point and the end point of each contour line is calculated. In a case where the distance is less than or equal to a preset third threshold (the third threshold being set to 1 in this application), the point set is determined to be approximately closed. The minimum positions of regions of all closed contour lines are stored into a list closed_min_list. Then, based on the minimum position of the closed region, the trough fitting line node list contours_list_with_line is truncated into a plurality of sublists, and the minimum position of the closed region is inserted at the beginning of each sublist. Finally, the trough fitting line node list contours_list_with_line is sorted according to height values, and the fitting trough line list fitting_line is updated accordingly. This process addresses the problem of accurately locating and processing closed regions in contour line data.

In this embodiment, the generated list contours_list_with_line is analyzed to determine whether this list contains segmented sublists representing closed regions, specifically as follows:

C1. In a case where the list does not contain segmented sublists representing closed regions, each trough line node in the list is sequentially traversed.

For each trough line node point′ᵢ in the list, a slope of the straight line between the trough line node and a subsequent trough line node point′ᵢ₊₁ is calculated, and each calculated slope is sequentially stored in the list slope_list.

$$slpoe\_list [ i ] = \frac{{y}_{i + 1} - {y}_{i}}{{x}_{i + 1} - {x}_{i}}$$

where xᵢ and yᵢ respectively represent the x-coordinate and y-coordinate of the trough line node point′ᵢ, and xᵢ₊₁ and yᵢ₊₁ respectively represent the x-coordinate and y-coordinate of the subsequent trough line node point′ᵢ₊₁.

Then, an average of these slopes is calculated, serving as a characteristic slope of the trough line, and is stored in the variable slope.

$$slope = \frac{1}{{n}^{′}} {\sum }_{{i}^{″} = 0}^{{n}^{′} - 1} slpoe\_list [ i ]$$

where n′ represents the number of data in the list slope_list, i″ represents an index of data in the list slope_list, slpoe_list[i], and represents a list of slopes between each trough line node point′ᵢ and a next trough line node point′ᵢ₊₁ thereof.

C2. In a case where the list contains segmented sublists representing closed regions, each trough line node in each segmented sublist is sequentially traversed.

For each trough line node point′ᵢ in a segmented sublist sublistⱼ, a slope of the straight line between the trough line node and a subsequent trough line node point′ᵢ₊₁ is calculated, and the result is stored in the list slope_list_j.

$$slope\_list \_j [ i ] = \frac{{y}_{i + 1} - {y}_{i}}{{x}_{i + 1} - {x}_{i}}$$

Subsequently, an average of the slopes for each segmented sublist is calculated, and the averages of all segmented sublists are further averaged to obtain an overall average slope of the entire trough line, which is finally stored in the variable slope.

The average slope of each segmented sublist is:

$$mean\_slope {\_j}^{′} [ j ] = \frac{1}{{n}_{{j}^{′}}} {\sum }_{{i}^{″} = 0}^{{n}_{j}^{′} - 1} slope\_list \_j [ i ]$$

The average slope of all segmented sublists is:

$$slope = \frac{1}{m} {\sum }_{{j}^{′} = 0}^{m - 1} mean\_slope {\_j}^{′} [ j ]$$

where slope represents the slope of the trough fitting line of all the segmented sublists, m represents the number of data in the list mean_slope_j′, j′ represents an index of data in the list mean_slope_j′, mean_slope_j′[j] represents a list of average slopes of the trough fitting lines of each segmented sublist, n_{j′} represents the number of data in the list slope_list_j[i], i″ represents an index of data in the list slope_list_j, slope_list_j[i] represents a list of slopes of straight lines between each trough line node point′ᵢ and a next trough line node point′ᵢ₊₁ in each segmented sublist sublistⱼ, xᵢ and yᵢ represent an x-coordinate and a y-coordinate of the trough line node point′ᵢ, respectively, and xᵢ₊₁ and yᵢ₊₁ represent an x-coordinate and a y-coordinate of the next trough line node point′ᵢ₊₁.

In this embodiment, the calculated slope slope of the trough fitting line is judged. In a case where the slope of the trough fitting line is less than 1, the trough line is considered a horizontal trough; otherwise, it is considered a vertical trough. Based on this criterion, slopes of all trough line segments are analyzed. In a case where no horizontal trough exists in the entire field, data for the next time is analyzed. In a case where no horizontal trough exists at any time, no horizontal trough is output, and the process is ended; otherwise, the process proceeds to the next step.

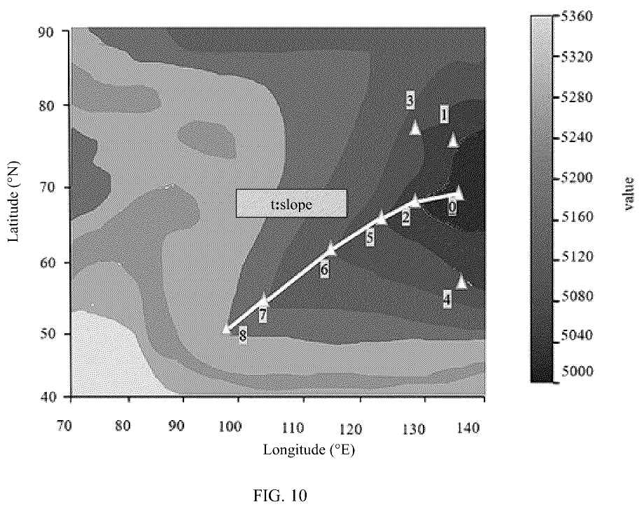

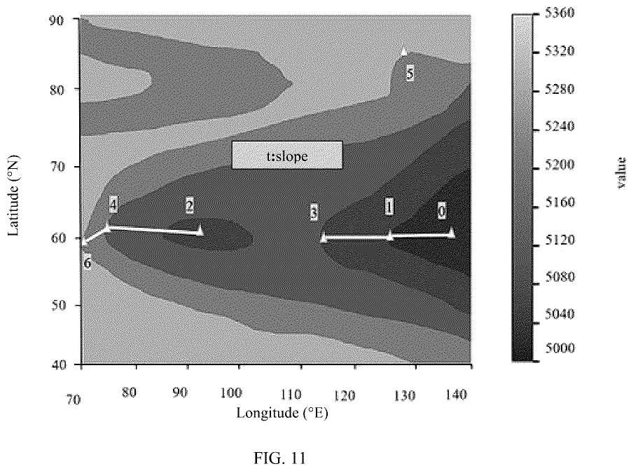

In this embodiment, when the trough fitting line is observed at a single time point, all points in the trough candidate node list trough_list are visualized, and the candidate nodes are sequentially numbered. The trough line nodes in the list fitting_line are then connected in sequence, thereby visualizing the trough fitting line and labeling a slope of this trough fitting line. A schematic visualization is shown in FIG. 10, where FIG. 10 is a schematic diagram of visualization of a trough fitting line at a time t (the list contours_list_with_line does not contain segmented sublists representing closed regions), and FIG. 11 is another schematic diagram of visualization of a trough fitting line at a time t (the list contours_list_with_line contains segmented sublists representing closed regions). In the figures, longitude represents a range from 70° E to 140° E, latitude represents a range from 90°N to 40°N, and value represents the geopotential height data at the corresponding point.

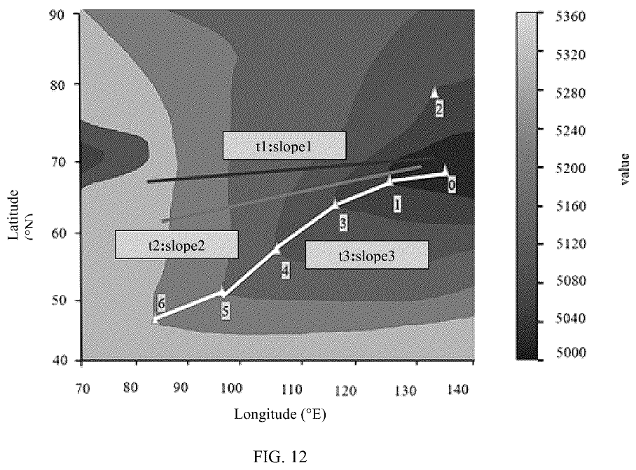

In this embodiment, when the trough fitting lines for a plurality of time points are visualized, the visualization at the final time point is used as the background. For time points other than the final time point, visualization is performed using different colors for each time point. Specifically, for each time point, the trough fitting line is drawn starting from a minimum-value point, using the slope of the trough fitting line at that time point. In addition, the slope is labeled in the format t:slope to facilitate distinguishing the trough line states at different time points. The corresponding schematic visualization is shown in FIG. 12. In FIGS. 10 to 14, the x-coordinate represents longitude in units of °E, the y-coordinate represents latitude in units of °N, and value represents the geopotential height at the corresponding point.

In this embodiment, whether a horizontal-to-vertical trough transition is determined based on changes in the north-south (longitudinal) length of the trough line, specifically as follows:

A time series is traversed, and data at each time is analyzed and processed. In the previous analysis, it is indicated that “a horizontal trough extends a long distance in the east-west direction, whereas the north-south length is very limited; after transforming into a vertical trough, the north-south length increases sharply.” Based on this, a determination rule is established. Each forecast time point is traversed. In a case where a horizontal trough exists at a previous time and no horizontal trough exists at the current time t, the next time point is detected.

In a case where a horizontal trough exists at a previous time t−1, calculating a north-south longitudinal length YYₜ₋₁ of the horizontal trough based on a difference between y-coordinates of a start point (x₀, y₀) and an end point (xₙ, yₙ) of the horizontal trough at the previous time t−1:

$${YY}_{t - 1} = {( {y}_{0} - {y}_{n} )}_{t - 1} .$$

A north-south longitudinal length YYₜ₋₁ of a horizontal trough is calculated by calculating a difference between y-coordinates of a start point (x₀, y₀) and an end point (xₙ, yₙ) of a horizontal trough at a current time t:

$${YY}_{t} = {( {y}_{0} - {y}_{n} )}_{t} .$$

A relative value of an increase amount ΔYY of a north-south longitudinal length of a horizontal trough at a current time relative to a previous time is calculated:

$$Δ Y Y = ( {YY}_{t} - {YY}_{t - 1} ) / {YY}_{t - 1} .$$

In a case where the increase amount ΔYY is greater than a preset growth threshold of 0.1, a horizontal-to-vertical trough transition occurs, a strong cold wave weather process is forecasted, and a start time of the horizontal-to-vertical trough transition is output.

Otherwise, the above steps are repeated for detection at the next time until detection and analysis for all forecast times are completed.

In a case where none of the times satisfy the horizontal-to-vertical trough transition determination condition, no horizontal-to-vertical trough transition is output for the forecast period, and the process is ended.

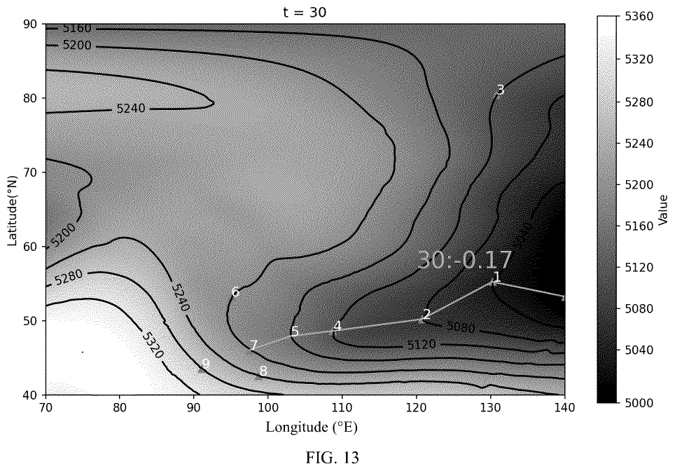

In this embodiment, a maximum geopotential height Hmax0 and a minimum geopotential height Hmin are selected from a selected region. The 500 hPa geopotential height field is analyzed based on contours with a reference value of 5000 gpm and contour intervals of 40 gpm. Analysis is performed using the 500 hPa geopotential height field over the Eurasia region at 06:00 on Dec. 28, 2020, as shown in FIG. 13. FIG. 13 is the visualization of the trough fitting line at t=30 (the list contours_list_with_line does not contain segmented sublists representing closed regions).

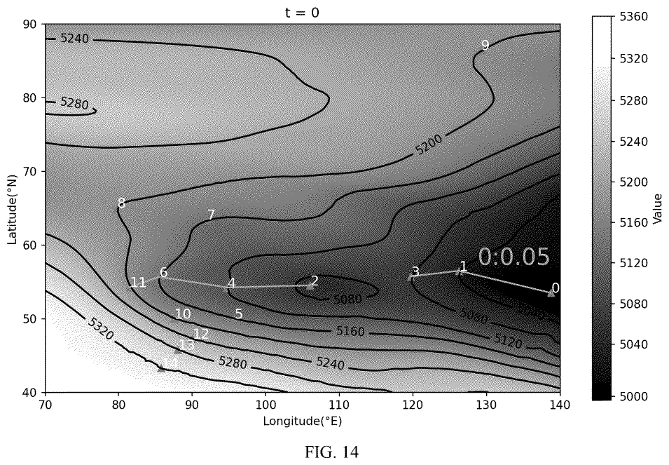

In this embodiment, analysis is performed using the 500 hPa geopotential height field over the Eurasia region at 00:00 on Dec. 27, 2020, as shown in FIG. 14. FIG. 14 is the visualization of the trough fitting line at t=0 (the list contours_list_with_line contains segmented sublists representing closed regions). In FIGS. 10 to 14, the x-coordinate represents longitude in units of ° E, the y-coordinate represents latitude in units of ° N, and t represents time.

In a case where strong cold waves from horizontal-to-vertical trough transition are forecasted, warnings can be issued to various industries to prompt corresponding response measures. For example, in the agricultural sector, measures to respond to cold waves include repairing damaged greenhouses, artificially increasing temperature within greenhouses (such as by electric heating or charcoal heating), and reinforcing greenhouse frames. In the industrial sector, measures include adding insulation to components sensitive to temperature, such as pipelines, heat exchangers, and water tanks, and reinforcing certain facilities, such as utility poles and rooftops.

In summary, the present application uses the most commonly used 500 hPa geopotential height field data in meteorological operations to automatically determine horizontal-to-vertical trough transitions, thereby enabling automatic forecasting of the most intense cold-wave weather events affecting China. This significantly enhances the automation level of operational forecasting and improves the capability for disaster prevention, mitigation, and relief against strong cold waves across large regions of China. The technical solution of the present application not only increases the accuracy and timeliness of cold-wave monitoring, but also provides robust data support for meteorological analysis and forecasting, enhancing the capability for meteorological disaster warning and emergency response. Compared with traditional methods, the method in the present application is direct, convenient, and efficient, achieving fully automated operation without personnel involvement, thereby significantly reducing the workload of staff and eliminating errors that may be introduced by subjective human judgment. The automation feature of the technical solution of the present application improves operational efficiency and reduces dependence on operators.

What is claimed is:

1. An automatic method for forecasting strong cold waves from horizontal-to-vertical trough transition using wave truncation, comprising the following steps:
S1. reading geopotential height data within a 500 hPa forecast key region in forecasting operations, and converting a screen coordinate system into a Cartesian coordinate system;
S2. performing contour analysis on the geopotential height data, extracting trough candidate nodes by a wave truncation method according to the analysis result, and constructing a trough line organization to identify the trough line;
S3. calculating a slope of each segmented trough fitting line;
S4. judging whether the slope is less than 1; if so, generating a horizontal trough and proceeding to S5; otherwise, generating a vertical trough, and calculating data at a next time to search for a horizontal trough; if no horizontal trough appears in all times, outputting no horizontal trough and ending the process;
S5. marking and numbering the trough candidate nodes, and calculating a north-south vertical length of the horizontal trough from coordinates of start and end points; and
S6. judging whether horizontal-to-vertical trough transition occurs based on changes in the north-south vertical length of the horizontal trough, thereby completing forecasting of the strong cold waves from horizontal-to-vertical trough transition.

2. The automatic method for forecasting strong cold waves from horizontal-to-vertical trough transition using wave truncation according to claim 1, wherein the S1 comprises the following steps:
S101. reading the geopotential height data within the 500 hPa forecast key region in forecasting operations, wherein the geopotential height data is three-dimensional data and comprises grid spacing of time interval, latitude, and longitude;
S102. performing geographic region selection on the read geopotential height data, calculating required latitude and longitude ranges, and extracting data within a corresponding region; and
S103. based on the extracted data within the corresponding region, converting the screen coordinate system into the Cartesian coordinate system by the following formula:
y=height−y*
wherein y represents vertical coordinate in the Cartesian coordinate system, height represents a vertical height of the screen, and y* represents a vertical coordinate in the screen coordinate system.

3. The automatic method for forecasting strong cold waves from horizontal-to-vertical trough transition using wave truncation according to claim 2, wherein the S2 comprises the following steps:
S201. creating a two-dimensional array data_t and performing contour analysis on the geopotential height data, and distributing the contour line nodes into a list contours according to elevation levels, wherein contours represents a list containing all sets of contour line nodes, and the two-dimensional array data_t is configured to store geopotential height data within a range of 90° N-40° N and 70° E-140° E at a time t;
S202. traversing each contour line in the list contours, and storing the contour line nodes sequentially as triplets into a list all_points, wherein each contour line comprises waves of a plurality of points;
S203. extracting truncation points using a wave truncation method, and determining the trough candidate nodes by a positive value of vector cross product;
S204. searching for a minimum value point in the two-dimensional array data_t and inserting the point into a trough candidate node list trough_list;
S205. based on the trough candidate node list trough_list, screening the candidate nodes according to an overall principle of the trough line tending westward, southward, and linear, forming the trough node organization, and constructing the trough node organization into a fitting trough line list fitting_line; and
S206. judging whether a closed contour exists using a convex hull algorithm, if so, searching for a minimum position of a region of the closed contour, reorganizing a trough line node list, and completing the identification of the trough line.

4. The automatic method for forecasting strong cold waves from horizontal-to-vertical trough transition using wave truncation according to claim 3, wherein the S201 comprises the following steps:
S2011. selecting a maximum geopotential height Hmax0 and a minimum geopotential height Hmin0 within the selected geographic region, wherein contour analysis is performed on a 500 hPa geopotential height field with 5000 gpm as a reference at intervals of 40 gpm;
S2012. creating the two-dimensional array data_t configured to store geopotential height data within the range of 90° N-40° N and 70° E-140° E at the time t; and
S2013. performing contour analysis on the two-dimensional array data_t, and distributing the contour line nodes into the list contours according to elevation levels.

5. The automatic method for forecasting strong cold waves from horizontal-to-vertical trough transition using wave truncation according to claim 2, wherein the S203 comprises the following steps:
S2031. constructing a straight line using start and end points of an original multi-wave curve, calculating a distance from each point on the original multi-wave curve to the straight line, and taking a point with a maximum distance as a first-level truncation point;
S2032. based on the first-level truncation point, dividing an original large multi-wave curve into two shortest sub-curves, connecting start and end points of the two sub-curves to form two new straight lines, calculating a distance from each point of the two sub-curves to a corresponding new straight line, and calculating and searching for a point with a maximum distance as a second-level truncation point;
S2033. repeating steps S2031 and S2032 until a maximum distance from points on the sub-curve to the corresponding straight line is less than a preset first distance threshold, thereby completing extraction of truncation points;
S2034. defining an order of previous and next points in a truncation point set: taking a current point as P, a previous point as a Pₚᵣₑᵥ, and a next point as Pₙₑₓₜ;
S2035. calculating vectors V₁ and V₂ for the previous and next points according to the defined points;
$${V}_{1} = P - {P}_{prev}$$
$${V}_{2} = {P}_{next} - P$$
S2036. performing a cross product calculation on the two vectors V₁ and V₂:
$${V}_{1} = ( {v}_{1 x} , {v}_{1 y} )$$
$${V}_{2} = ( {v}_{2 x} , {v}_{2 y} )$$
$${V}_{1} \times {V}_{2} = {v}_{1 x} {v}_{2 y} - {v}_{1 y} {v}_{2 x}$$
wherein v₁ₓ, v_{1y} represents components of the vector V₁ in x and y directions, respectively; and v₂ₓ, v_{2y} represents components of the vector V₂ in x and y directions, respectively; and
S2037. in a case where the cross product result is positive, defining the current point as a trough candidate node, thereby judging and identifying the trough candidate node from the truncation point set.

6. The automatic method for forecasting strong cold waves from horizontal-to-vertical trough transition using wave truncation according to claim 2, wherein the S205 comprises the following steps:
S2051. sorting the trough candidate node list trough_list according to geopotential height;
S2052. grouping trough candidate nodes in the sorted trough candidate node list trough_list according to contour lines on which the nodes are located, and storing a grouping result into a list collected_list;
S2053. constructing a list now_isotherm_point_index_list configured to store indexes of nodes currently selected to form the trough fitting line, wherein an initial value is an index 0 of a first point, that is, a minimum value point in the two-dimensional array data_t;
S2054. constructing a list fitting_line configured to store the selected trough line nodes in the form of a dictionary;
S2055. sequentially traversing each contour line in the list collected_list, creating empty lists each_contour_distance_list and angle_list for each contour line in collected_list starting from index 1, taking a last node in the current trough fitting line as start_point, traversing trough candidate nodes in each contour line, and calculating a Euclidean distance distance between each trough candidate node in a current contour and the last node start_point in the current trough fitting line:
$$distance = \sqrt{{( x - {x}_{0} )}^{2} + {( y - {y}_{0} )}^{2}}$$
wherein x₀ represents x-coordinate of a node each_point in the current contour, y₀ represents y-coordinate of the node each_point in the current contour, x represents x-coordinate of a node start_point in the current trough fitting line, y represents y-coordinate of the node start_point in the current trough fitting line, and both the node each_point and the node start_point are trough candidate nodes;
S2056. determining a position of the node each_point relative to the node start_point by the following formula:
$$dx = e ach\_point \_x - st art\_point \_x$$
$$dy = e ach\_point \_y - start\_point \_y$$
wherein dx and dy represent positions of the node each_point relative to the node start_point, each_point_x and each_point_y represent an x-coordinate and a y-coordinate of the node each_point, respectively, and start_point_x and start_point_y represent an x-coordinate and a y-coordinate of the node start_point, respectively;
S2057. in a case where dx<0, that is, the node each_point is on the left side of the node start_point, and a number of points currently selected to form the trough fitting line stored in the list now_isotherm_point_index_list is greater than or equal to 2, calculating angles among the current node each_point and last two nodes in the list now_isotherm_point_index_list, wherein the last two nodes for calculation are the most recently selected nodes stored in the list now_isotherm_point_index_list forming the trough fitting line, and storing the angles among the three nodes into the list angle_list, wherein the three nodes comprise the current node and the last two nodes, and the angles are formed by the current node each_point and the last two nodes in the list now_isotherm_point_index_list, with the last node in the list now_isotherm_point_index_list located at the center;
in a case where dx<0, that is, the node each_point is on the left side of the node start_point, and dy>0, that is, the node each_point is above the node start_point, calculating a distance between the node each_point and the node start_point, and adding the distance between the node each_point and the node start_point to the list each_contour_distance_list; otherwise, multiplying the distance between the node each_point and the node start_point by a second distance threshold, and adding a result of multiplication to the list each_contour_distance_list;
in a case where dx>0, that is, the node each_point is on the right side of the node start_point, setting a distance to 99999 according to meteorological business specifications, and adding the distance to the list each_contour_distance_list; and setting an angle to 90°, and adding the angle to the list angle_list; and
S2058. screening the three cases of S2057 to obtain the fitting trough line list fitting_line.

7. The automatic method for forecasting strong cold waves from horizontal-to-vertical trough transition using wave truncation according to claim 6, wherein the S2058 comprises the following steps:
S20581. searching for a trough candidate node in the current contour that is closest to the node start_point, and recording an index of a minimum distance as minize_index:
$$minize\_index = \underbrace{argmin}_{{i}^{′}} \{ distance ( {point}_{i} , start\_point ) \}$$
wherein minize_index represents the index of the minimum distance, argmin represents an index that minimizes an objective function distance (pointᵢ, start_point), pointᵢ represents a trough candidate node in the current contour currently being used to calculate the distance to the node start_point, and i′ represents an index of the trough candidate node in the current contour that is closest to the node start_point;
S20582. calculating a difference angle_diff_{[j]} between each angle in the list angle_list and 180°:
$${angle\_diff}_{[ j ]} = \vert {angle\_list}_{[ j ]} - 180 ° \vert$$
wherein angle_list_{[j]} represents a list used for recording and storing angles angle among three nodes, comprising a current trough candidate node j and the last two nodes in the list of the most recently selected nodes forming the trough fitting line;
S20583. in a case where |angle_list|≥2 and |now_isotherm_point_index_list|≥3, then
$$nearest\_flatten \_angle \_index = \underbrace{argmin}_{{i}^{′}} \{ {angle\_diff}_{[ j ]} \} ;$$
wherein |angle_list|≥2 represents that the number of angles existing in the list angle_list is greater than 2, |now_isotherm_point_index_list|≥3 represents that the number of points existing in the list now_isotherm_point_index_list is greater than 3, and
$$nearest\_flatten \_angle \_index = \underbrace{argmin}_{{i}^{′}} \{ {angle\_diff}_{[ j ]} \}$$
represents updating the index nearest_flatten_angle_index to point to a trough candidate node whose an included angle with a previous trough fitting line is closest to 180°;
S20584. comparing whether the index nearest_flatten_angle_index is inconsistent with the index minize_index; in a case where nearest_flatten_angle_index≠minize_index, and each_contour_distance_list[nearest_flatten_angle_index] is less than or equal to a preset first threshold, updating the index minize_index to the index nearest_flatten_angle_index;
S20585. adding coordinates of a node in the current contour line that satisfies a fitting condition of a trough fitting line to the fitting trough line list fitting_line, and adding an index of the node to the list now_isotherm_point_index_list; updating count by increasing the number of the currently selected nodes forming the trough fitting line by one, and performing the next traversal; in a case where a length of the list each_contour_distance_list is 1 and the value exceeds a set second threshold, indicating that only one point exists in the current contour line and the distance is the maximum, ending the loop and stopping the extension of the trough line, wherein count represents a total number of currently selected nodes forming the trough fitting line, and the node satisfying the fitting condition of the trough fitting line corresponds to the index minize_index; and
S20586. storing information of trough candidate nodes corresponding to all indexes in the list now_isotherm_point_index_list into the list contours_list_with_line, so as to complete the fitting of the trough line.

8. The automatic method for forecasting strong cold waves from horizontal-to-vertical trough transition using wave truncation according to claim 3, wherein the S206 specifically is as follows:
calculating a distance between a start point and an end point of each contour line;
in a case where the distance is less than a preset third threshold, judging that a point set array contour_data is approximately closed; or
in a case where the distance is equal to the preset third threshold, judging that the point set array contour_data is approximately closed;
storing minimum positions of regions of all closed contour lines into a list closed_min_list;
truncating a trough fitting line node list contours_list_with_line into a plurality of sublists according to the minimum positions of the closed regions; and
inserting a minimum position of each closed region at the beginning of each sublist, sorting the trough fitting line node list contours_list_with_line according to height values, and updating a fitting trough line list fitting_line.

9. The automatic method for forecasting strong cold waves from horizontal-to-vertical trough transition using wave truncation according to claim 7, wherein the S3 comprises the following steps:
S301. analyzing a list contours_list_with_line to judge whether the list comprises segmented sublists; if so, proceeding to step S303; otherwise, proceeding to step S302;
S302. calculating slopes between trough line nodes, obtaining an average value of the slopes, taking the average value as a slope of a trough fitting line, and storing the slope of the trough fitting line:
$$slope = \frac{1}{{n}^{′}} {\sum }_{{i}^{″} = 0}^{{n}^{′} - 1} slpoe\_list [ i ]$$
$$slpoe\_list [ i ] = \frac{{y}_{i + 1} - {y}_{i}}{{x}_{i + 1} - {x}_{i}}$$
wherein slope represents the slope of the trough fitting line, n′ represents the number of data in the list slope_list, i″ represents an index of data in the list slope_list, and slpoe_list[i] represents a list of slopes between each trough line node point′ᵢ, and a next trough line node point′ᵢ₊₁ thereof; and
S303. sequentially traversing the trough line nodes in each segmented sublist, calculating slopes between the trough line nodes in each segmented sublist, obtaining an average value of the slopes as an average slope of each segmented sublist, performing an averaging process on the average slopes of all the segmented sublists to obtain a slope of a trough fitting line of all the segmented sublists, and storing the slope of the trough fitting line of all the segmented sublists:
$$slope = \frac{1}{m} {\sum }_{{j}^{′} = 0}^{m - 1} mean\_slope {\_j}^{′} [ j ]$$
$$mean\_slope {\_j}^{′} [ j ] = \frac{1}{{n}_{{j}^{′}}} {\sum }_{{i}^{″} = 0}^{{n}_{j}^{′} - 1} slope\_list \_j [ i ]$$
$$slope\_list \_j [ i ] = \frac{{y}_{i + 1} - {y}_{i}}{{x}_{i + 1} - {x}_{i}}$$
wherein slope represents the slope of the trough fitting line of all the segmented sublists, m represents the number of data in the list mean_slope_j′, j′ represents an index of data in the list mean_slope_j′, mean_slope_j′[j] represents a list of average slopes of the trough fitting lines of each segmented sublist, n_{j′} represents the number of data in the list slope_list_j[i], i″ represents an index of data in the list slope_list_j, slope_list_j[i] represents a list of slopes of straight lines between each trough line node point and a next trough line node point′ᵢ₊₁ in each segmented sublist sublistⱼ, xᵢ and yᵢ represent an x-coordinate and a y-coordinate of the trough line node point′ᵢ, respectively, and xᵢ₊₁ and yᵢ₊₁ represent an x-coordinate and a y-coordinate of the next trough line node point′ᵢ₊₁.

10. The automatic method for forecasting strong cold waves from horizontal-to-vertical trough transition using wave truncation according to claim 1, wherein the S5 specifically is as follows:
traversing a time series and analyzing and processing data at each time;
in a case where a horizontal trough exists at a previous time t−1, calculating a north-south longitudinal length YYₜ₋₁ of the horizontal trough based on a difference between y-coordinates of a start point (x₀, y₀) and an end point (xₙ, yₙ) of the horizontal trough at the previous time t−1:
$${YY}_{t - 1} = {( {y}_{0} - {y}_{n} )}_{t - 1} ;$$
calculating a north-south longitudinal length YYₜ₋₁ of a current horizontal trough by calculating a difference between y-coordinates of a start point (x₀, y₀) and an end point (xₙ, yₙ) of a horizontal trough at a current time t:
$${YY}_{t} = {( {y}_{0} - {y}_{n} )}_{í} .$$

11. The automatic method for forecasting strong cold waves from horizontal-to-vertical trough transition using wave truncation according to claim 10, wherein the S6 specifically is as follows:
traversing each time point, calculating a relative value of an increase amount ΔYY of a north-south longitudinal length of a horizontal trough at a current time relative to a previous time:
$$Δ Y Y = ( {YY}_{t} - {YY}_{t - 1} ) / {YY}_{t - 1}$$
in a case where the increase amount ΔYY is greater than a preset growth threshold, judging that a horizontal-to-vertical trough transition occurs, forecasting a strong cold wave weather process, and outputting a start time of the horizontal-to-vertical trough transition; and
otherwise, in a case where all times do not satisfy the judgment condition of the horizontal-to-vertical trough transition, outputting that no horizontal-to-vertical trough transition occurs during the forecast period, and ending the process.
